(19) United States
(12) Patent Application Publication
(10) Pub. No.: US 2024/0272473 A1
(43) Pub. Date: Aug. 15, 2024

(54) HIGH EFFICIENCY REFLECTIVE LIQUID CRYSTAL POLARIZATION HOLOGRAM FOR MULTI-WAVELENGTHS

(71) Applicant: Meta Platforms Technologies, LLC, Menlo Park, CA (US)

(72) Inventors: Hsien-Hui CHENG, Woodinville, WA (US); Sawyer MILLER, Bellevue, WA (US); Xiayu FENG, Kirkland, WA (US); Mengfei WANG, Woodinville, WA (US); Yuge HUANG, Painted Post, NY (US); Michael ESCUTI, Redmond, WA (US)

(21) Appl. No.: 18/169,872

(22) Filed: Feb. 15, 2023

(51) Int. Cl. G02F 1/1335; G02B 5/32; G02F 1/13363; G02F 1/1337

(52) U.S. Cl. CPC G02F 1/133543; G02B 5/32; G02F 1/133636; G02F 1/133637; G02F 1/133776

(57) ABSTRACT

A device is provided. The device includes an optical film including optically anisotropic molecules configured to form a plurality of helical structures with a plurality of helical axes and a helical pitch. The helical pitch is a distance along a helical axis over which an azimuthal angle of an optically anisotropic molecule vary by a predetermined value. Over the helical pitch of a helical structure, the azimuthal angle of the optically anisotropic molecule is configured to vary nonlinearly with respect to a distance from a starting point of the helical pitch to a local point at which the optically anisotropic molecule is located along the helical axis.

### TECHNICAL FIELD

The present disclosure generally relates to devices and, more specifically, to a high efficiency reflective liquid crystal polarization hologram for multi-wavelengths.

### BACKGROUND

Liquid crystal polarization holograms (“LCPHs”) combine features of liquid crystal devices and polarization holograms. Liquid crystal displays (“LCDs”), having grown to a trillion dollar industry over the past decades, are the most successful examples of liquid crystal devices. The LCD industry has made tremendous investments to scale manufacturing, from the low end G2.5 manufacturing line to the high end G10.5+ to meet the market demands for displays. However, the LCD industry has recently faced competition from organic light-emitting diodes (“OLED”), e-paper and other emerging display technologies, which has flattened the growth rate of LCD industry and has rendered significant early generation capacity redundant. This provides an opportunity to repurpose the LCD idle capacity and existing supply chain to manufacture novel LC optical devices characterized by their polarization holograms.

LCPHs or LCPH elements have features such as small thickness (e.g., about 1 um), light weight, compactness, large aperture, high efficiency, simple fabrication, etc. Thus, LCPH elements have gained increasing interests in optical device and system applications, e.g., near-eye displays (“NEDs”), head-up displays (“HUDs”), head-mounted displays (“HAMDs”), smart phones, laptops, televisions, or vehicles, etc. For example, LCPH elements may be used for addressing accommodation-vergence conflict, enabling thin and highly efficient eye-tracking and depth sensing in space constrained optical systems, developing optical combiners for image formation, correcting chromatic aberrations for image resolution enhancement of refractive optical elements in compact optical systems, and improving the efficiency and reducing the size of optical systems.

### SUMMARY OF THE DISCLOSURE

Consistent with an aspect of the present disclosure, a device is provided. The device includes an optical film including optically anisotropic molecules configured to form a plurality of helical structures with a plurality of helical axes and a helical pitch. The helical pitch is a distance along a helical axis over which an azimuthal angle of an optically anisotropic molecule vary by a predetermined value. Over the helical pitch of a helical structure, the azimuthal angle of the optically anisotropic molecule is configured to vary nonlinearly with respect to a distance from a starting point of the helical pitch to a local point at which the optically anisotropic molecule is located along the helical axis.

Consistent with an aspect of the present disclosure, a method is provided. The method includes generating a plurality of polarized beams. The plurality of polarized beams include at least three circularly polarized beams, the at least three circularly polarized beams include one or more left-handed circularly polarized beams and one or more right-handed circularly polarized beams, and the at least three circularly polarized beams are configured to interfere with one another to generate a polarization interference pattern. The method also includes exposing a polarization sensitive recording medium to the polarization interference pattern. The method further includes forming an optically anisotropic film on the polarization sensitive recording medium that has been exposed to the polarization interference pattern. The optically anisotropic film includes a mixture of a host birefringent material and a chiral dopant.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic diagram of a conventional cholesteric liquid crystal (“CLC”) element;

FIG. 1B illustrates a three-dimensional (“3D”) view of a conventional reflective polarization volume hologram (“R-PVH”) element;

FIG. 1C illustrates simulation results showing a relationship between a reflection efficiency and a wavelength of an incident light of a conventional broadband CLC device including three CLC layers;

FIGS. 1D and 1E schematically illustrate diagrams showing a relationship between a reflection efficiency and a wavelength of an incident light of a conventional broadband CLC device including two CLC layers;

FIGS. 2A and 2B illustrate schematic diagrams of a liquid crystal polarization hologram (“LCPH”) element, according to an embodiment of the present disclosure;

FIG. 2C illustrates a schematic diagram of an LCPH element, according to an embodiment of the present disclosure;

FIG. 2D illustrates simulation results showing a linear relationship between an azimuthal angle and an out-of-plane axis distance over a single helical pitch of a conventional reflective PVH (“R-PVH”) element, and various nonlinear relationships between an azimuthal angle and an out-of-plane axis distance over a single helical pitch of the LCPH element shown in FIG. 2A, according to various embodiments of the present disclosure;

FIG. 2E illustrates simulation results showing azimuthal angles of optically anisotropic molecules for a series of out-of-plane axis distances over a single helical pitch of a conventional R-PVH element, and azimuthal angles of optically anisotropic molecules for a series of out-of-plane axis distances and a series of frequencies of a nonlinear term, over a single helical pitch of the LCPH element shown in FIG. 2A, according to various embodiments of the present disclosure;

FIG. 2F illustrates a 3D exploded view of a portion of the LCPH element shown in FIG. 2A, showing a nonlinear azimuthal angle variation of optically anisotropic molecules over a single helical pitch, according to an embodiment of the present disclosure;

FIG. 3A illustrates simulation results showing relationships between a reflection efficiency and a wavelength of an incident light of the LCPH element shown in FIG. 2C, according to an embodiment of the present disclosure;

FIG. 3B illustrates simulation results showing relationships between a reflection efficiency and an angle of incidence (“AOI”) of blue and green incident lights for both a conventional CLC element and the LCPH element shown in FIG. 2C;

FIG. 3C illustrates simulation results showing a relationship between a reflection efficiency and a wavelength of an incident light of the LCPH element shown in FIGS. 2A and 2B, according to an embodiment of the present disclosure;

FIG. 3D illustrates simulation results showing a relationship between a reflection efficiency and a wavelength of an incident light of a conventional R-PVH element;

FIG. 4A illustrates simulation results showing relationships between a reflection efficiency and a wavelength of an incident light of the LCPH element shown in FIG. 2C for various angles of incidence, according to an embodiment of the present disclosure;

FIG. 4B illustrates simulation results showing relationships between a reflection efficiency and an AOI of blue, green, and red incident lights of the LCPH element shown in FIG. 2C, according to an embodiment of the present disclosure,

FIG. 4C illustrates simulation results showing a relationship between a reflection efficiency and a wavelength of an incident light of the LCPH element shown in FIGS. 2A and 2B, according to an embodiment of the present disclosure;

FIGS. 5A-5E illustrate schematic diagrams of various LCPH devices, according to various embodiments of the present disclosure;

FIG. 6 schematically illustrates a system including one or more LCPH devices, according to an embodiment of the present disclosure;

FIG. 7 schematically illustrates a system including one or more LCPH devices, according to an embodiment of the present disclosure;

FIG. 8A schematically illustrates a system including one or more LCPH devices, according to an embodiment of the present disclosure;

FIG. 8B schematically illustrates an optical path of an image light from a display element to an eye-box region of the system shown in FIG. 8A, according to an embodiment of the present disclosure;

FIG. 9 schematically illustrates a system including one or more LCPH devices, according to an embodiment of the present disclosure;

FIG. 10A illustrates a schematic diagram of an artificial reality device, according to an embodiment of the present disclosure;

FIG. 10B illustrates a schematic cross sectional view of half of the artificial reality device shown in FIG. 10A, according to an embodiment of the present disclosure;

FIGS. 11A-11F schematically illustrate processes for fabricating an LCPH element, according to an embodiment of the present disclosure;

FIGS. 12A and 12B schematically illustrate processes for fabricating an LCPH element, according to an embodiment of the present disclosure;

FIGS. 13A-13C schematically illustrate processes for fabricating an LCPH element, according to an embodiment of the present disclosure; and

FIGS. 14A and 14B are flowcharts illustrating methods for fabricating an LCPH element, according to various embodiments of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction or a normal of a surface of the film, layer, coating, or plate. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane. In some embodiments, an “out-of-plane” direction or orientation may form an acute or right angle with respect to the film plane.

The term “orthogonal” as used in “orthogonal polarizations” or the term “orthogonally” as used in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, block or the like that describes processing of a light means that a majority portion, including all, of a light is transmitted, reflected, diffracted, or blocked, etc. The majority portion may be a predetermined percentage (greater than 50%) of the entire light, such as 100%, 95%, 90%, 85%, 80%, etc., which may be determined based on specific application needs.

An angle of a beam (e.g., a diffraction angle of a diffracted beam, a reflection angle of a reflected light, or an incidence angle of an incident beam) with respect to a normal of a surface of an optical element can be defined as a positive angle or a negative angle, depending on the angular relationship between a propagating direction of the beam and the normal of the surface. For example, when a virtual line representing the propagating direction of the beam deviates from the normal in a clockwise direction (or counter-clockwise direction), the angle of the beam relative to the normal may be defined as a positive angle, and when the virtual line representing the propagating direction of the beam deviates from the normal in the counter-clockwise direction (or clockwise direction), the angle of the beam relative to the normal may be defined as a negative angle.

As used herein, the term “liquid crystal compound” or “mesogenic compound” may refer to a compound including one or more calamitic (rod- or board/lath-shaped) or discotic (disk-shaped) mesogenic groups. The term “mesogenic group” may refer to a group with the ability to induce liquid crystalline phase (or mesophase) behavior. In some embodiments, the compounds including mesogenic groups may not exhibit a liquid crystal (“LC”) phase themselves. Instead, the compounds may exhibit the LC phase when mixed with other compounds. In some embodiments, the compounds may exhibit the LC phase when the compounds, or the mixture containing the compounds, are polymerized. For simplicity of discussion, the term “liquid crystal” is used hereinafter for both mesogenic and LC materials. In some embodiments, a calamitic mesogenic group may include a mesogenic core including one or more aromatic or non-aromatic cyclic groups connected to each other directly or via linkage groups. In some embodiments, a calamitic mesogenic group may include terminal groups attached to the ends of the mesogenic core. In some embodiments, a calamitic mesogenic group may include one or more lateral groups attached to a long side of the mesogenic core. These terminal and lateral groups may be selected from, e.g., carbyl or hydrocarbyl groups, polar groups such as halogen, nitro, hydroxy, etc., or polymerizable groups.

As used herein, the term “reactive mesogen” (“RM”) may refer to a polymerizable mesogenic or a liquid crystal compound. A polymerizable compound with one polymerizable group may be also referred to as a “mono-reactive” compound. A compound with two polymerizable groups may be referred to as a “di-reactive” compound, and a compound with more than two polymerizable groups may be referred to as a “multi-reactive” compound. Compounds without a polymerizable group may be also referred to as “non-reactive” compounds. For discussion purposes, the term “liquid crystal” may encompass both polymerizable liquid crystal and non-polymerizable liquid crystal. As used herein, the term “director” may refer to a preferred orientation direction of long molecular axes (e.g., in case of calamitic compounds) or short molecular axes (e.g., in case of discotic compounds) of the LC molecules. The term “optic axis” may refer to a direction in a crystal. A light propagating in the optic axis direction may not experience birefringence (or double refraction). An optic axis may be a direction rather than a single line.

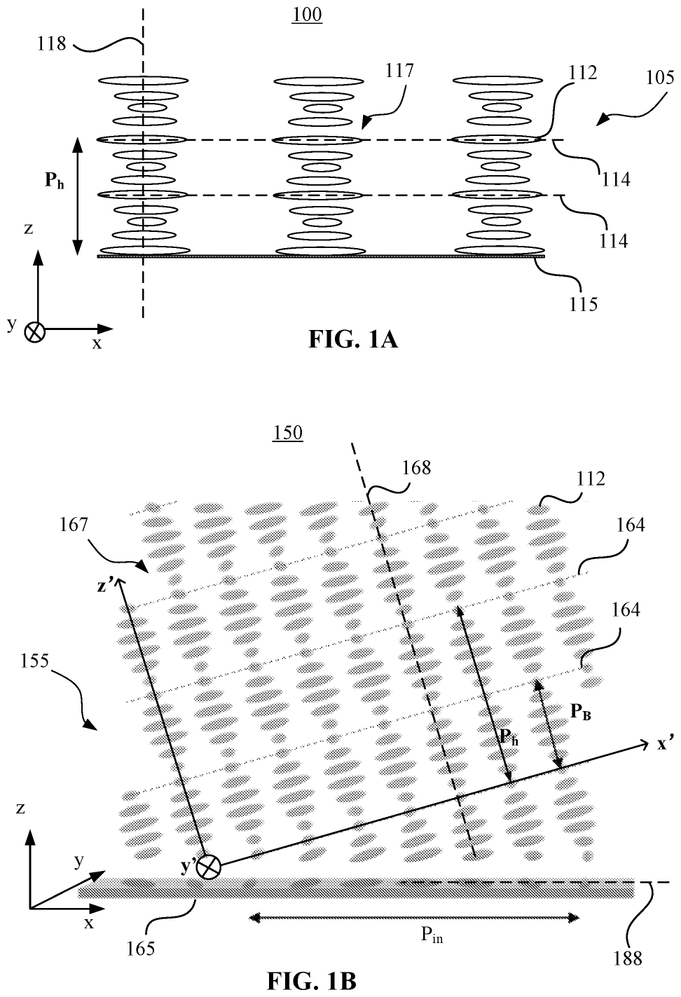

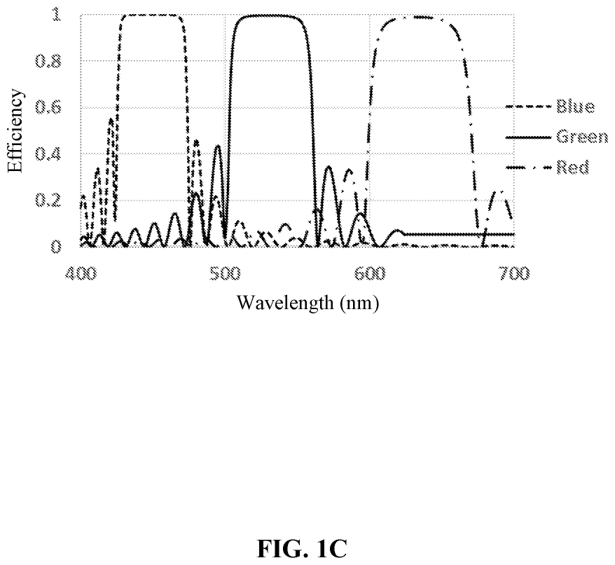

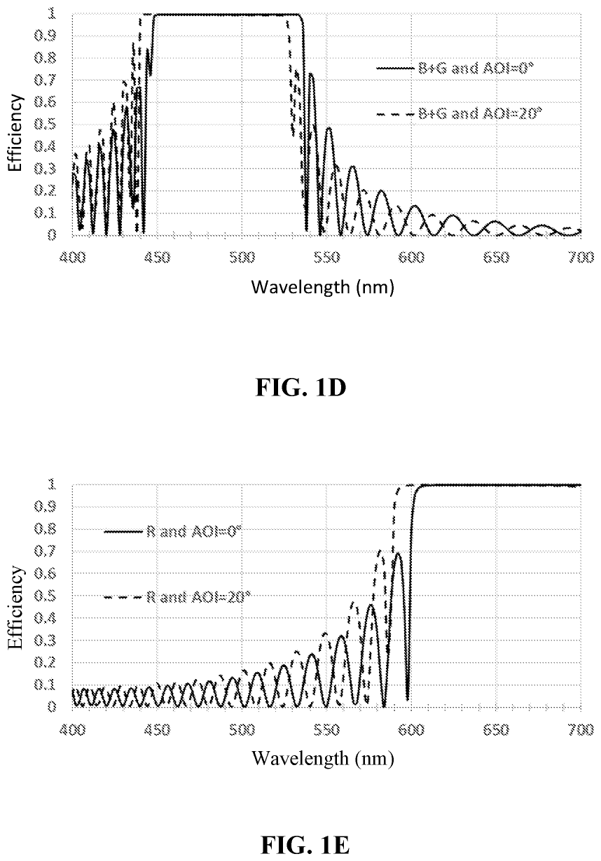

FIG. 1A illustrates an x-z sectional view of a conventional CLC element 100. As shown in FIG. 1A, the CLC element 100 may include a CLC layer 105. LC molecules 112 located in close proximity to a surface 115 of the CLC layer 105 may have a uniform in-plane orientation pattern. For example, the LC molecules 112 may be uniformly aligned in an x-axis direction shown in FIG. 1A. Within the volume of the CLC layer 105, the LC molecules 112 may be arranged to form a plurality of helical structures 117 with a plurality of helical axes 118, and a plurality of series of Bragg planes 114. The helical axis 118 may be perpendicular to the surface 115, extending in a thickness direction of the CLC layer 105, and the Bragg planes 114 may be parallel to the surface 115 of the CLC layer 105. FIG. 1A shows that the Bragg planes 114 are within an x-y plane, and the helical axis 118 is extending in a z-axis direction, and the Bragg planes 114 are perpendicular to the helical axis 118.

In each helical structure 117, the LC molecules 112 may continuously rotate around the helical axis 118 in a predetermined rotation direction, and azimuthal angles of the LC molecules 112 may exhibit a continuous periodic variation along the helical axis 118. An azimuthal angle of the LC molecule 112 may be defined as an angle of the LC director with respect to a predetermined in-plane direction within the Bragg planes 114, e.g., an x-axis direction in FIG. 1A. The azimuthal angle of the LC molecule 112 may have a value within the range from 0° to 360° (including 0° and 360°). A helical pitch Pₕ of the helical structure 117 may be defined as a distance along the helical axis 118 over which the azimuthal angles of the LC molecules 112 vary by 360°.

Over a single helical pitch Pₕ of the helical structure 117, the LC molecules 112 may have a linear azimuthal angle variation along the helical axis 118. For example, the azimuthal angle of the LC molecule 112 may be linearly proportional to a distance from a starting point of the single helical pitch Pₕ (e.g., a starting point where an azimuthal angle φ=0°) to a local point at which the LC molecule 112 is located along the helical axis 118. For discussion purposes, over the single helical pitch Pₕ of the helical structure 117, the distance from the starting point (where the azimuthal angle φ=0°) to a local point at which the LC molecule 112 is located along the helical axis 118 may be referred to as an out-of-plane axis distance of the LC molecule 112. For example, over the single helical pitch Pₕ of the helical structure 117, the azimuthal angle φ of the LC molecule 112 may vary linearly with respect to an out-of-plane axis distance z of the LC molecules 112, according to a linear function φ(z)=180°*z/P_{B}, where P_{B} is the Bragg period (that is half of the helical pitch Pₕ). When the out-of-plane axis distances z of the LC molecules 112 are 0, 0.25*P_{B}, 0.5*P_{B}, 0.75*P_{B}, P_{B}, 1.25*P_{B}, 1.5*P_{B}, 1.75*P_{B}, and 2*P_{B}, respectively, the azimuthal angles φ of the LC molecules 112 may be 0°, 45°, 90°, 135°, 180°, 225°, 270°, 315°, and 360°, respectively.

FIG. 1B illustrates a 3D view of a conventional reflective PVH (“R-PVH”) element 150. The R-PVH element 150 based on self-organized CLCs may be referred to as a slanted or patterned CLC element. Referring to FIG. 1B, the R-PVH element 150 may include an R-PVH layer 155. Within the volume of the R-PVH layer 155, the LC molecules 112 may be arranged to form a plurality of helical structures 167 with a plurality of helical axes 168, and a plurality of series of Bragg planes 164. The helical axis 168 may be slanted with respect to a surface 165 of the R-PVH layer 155, and the Bragg planes 164 may form an angle (e.g., an acute angle) with the surface 165. The x-y-z coordinate system shown in FIG. 1B refers to a global coordinate system for the R-PVH element 150, whereas an x′-y′-z′ coordinate system shown in FIG. 1B refers to a local coordinate system for the helical structure 167. FIG. 1B shows that the Bragg planes 164 are within an x′-y′ plane, and the helical axis 168 is extending in a z′-axis direction. In the non-slanted CLC element 100 shown in FIG. 1A, the x′-y′-z′ coordinate system may coincide with the x-y-z coordinate system.

Similar to the non-slanted CLC element 100 shown in FIG. 1A, over the single helical pitch Pₕ, the azimuthal angle φ of the LC molecule 112 may be linearly proportional to a distance from a starting point of the single helical pitch Pₕ (e.g., where an azimuthal angle φ=0°) to a local point at which the LC molecule 112 is located along the helical axis 168. In addition, the LC molecules 112 located in close proximity to the surface 165 may have a non-uniform in-plane orientation pattern with an in-plane pitch Pᵢₙ, in which the directors of the LC molecules 112 may rotate in a predetermined in-plane direction (or in-plane axis) 188 within the surface 165. Thus, the azimuthal angle of the LC molecules 112 located in close proximity to the surface 165 may vary in the predetermined in-plane direction 188. The azimuthal angle of the LC molecules 112 located in close proximity to the surface 165 of the R-PVH layer 155 may be defined as an angle of the LC director with respect to the predetermined in-plane direction 188 within the surface 165, e.g., the x-axis direction shown in FIG. 1B. The in-plane pitch Pᵢₙ may be defined as a distance along the predetermined in-plane direction 188 over which the azimuthal angles of the LC molecules 112 located in close proximity to the surface 165 vary by 180°. For discussion purposes, FIG. 1B shows that the azimuthal angle of the LC molecules 112 may vary periodically in the predetermined in-plane direction 188 with a constant in-plane pitch Pᵢₙ.

Over a single in-plane pitch Pᵢₙ of the in-plane orientation pattern, the LC molecules 112 located in close proximity to the surface 165 may also have a linear azimuthal angle variation along the predetermined in-plane direction 188, e.g., the azimuthal angle of the LC molecule 112 may be linearly proportional to a distance from a starting point of the in-plane pitch Pᵢₙ(e.g., where an azimuthal angle=0°) to a local point at which the LC molecule 112 is located along the predetermined in-plane direction 188. For discussion purposes, over the single in-plane pitch Pᵢₙ of the in-plane orientation pattern, the distance from the starting point (where the azimuthal angle=0°) to a local point at which the LC molecule 112 is located along the predetermined in-plane direction 188 may be referred to as an in-plane axis distance of the LC molecule 112. For example, over the single helical pitch Pₕ of the helical structure 167, the azimuthal angle φ of the LC molecule 112 may vary according to the function φ(x)=180° *x/Pᵢₙ, where x is an in-plane axis distance of the LC molecules 112, and Pᵢₙ is the in-plane pitch of the in-plane orientation pattern. When the in-plane axis distances x of the LC molecules 112 located in close proximity to the surface 165 are 0, 0.25*Pᵢₙ, 0.5*Pᵢₙ, 0.75*Pᵢₙ, and Pᵢₙ, respectively, the azimuthal angles φ of the LC molecules 112 may be 0°, 45°, 90°, 135°, 180°, respectively.

In conventional technologies, the reflection bandwidth of conventional CLC layers may be limited by the birefringence (Δn) of a host birefringent material used in the conventional CLC layers. To broaden the reflection bandwidth of the CLC elements, e.g., to cover substantially the entire visible spectral range, three CLC layers that respectively reflect or deflect red, green, and blue lights with high efficiency over a large angle of incidence (“AOI”) range may be stacked to form a broadband CLC device. FIG. 1C illustrates simulation results showing a relationship between a reflection efficiency and a wavelength of an incident light of a conventional broadband CLC device including three CLC layers. As shown in FIG. 1C, the three CLC layers may respectively reflect a red (“R”) light, a green (“G”) light, and a blue (“B”) light with a substantially high efficiency (e.g., greater than 98%), and each CLC layer may include a host birefringent material with a birefringence of 0.16.

In some cases, when the host birefringent material has a large birefringence, e.g., greater than 0.5, two CLC layers that reflect or deflect red (“R”), green (“G”), and blue (“B”) lights may be stacked to form a broadband CLC device. FIGS. 1D and 1E schematically illustrate diagrams showing a relationship between a normalized reflection efficiency and a wavelength of an incident light of a conventional broadband CLC device including two CLC layers. As shown in FIG. 1D, a first CLC layer may exhibit a single reflection band that includes both green wavelength range and blue wavelength range, thereby reflecting both green (“G”) light and blue (“B”) light. As shown in FIG. 1E, a second CLC layer may exhibit a single reflection band that includes the red wavelength range, thereby reflecting the red (“R”) light. FIG. 1D also shows the reflection spectrum of the first CLC layer when the AOI is 0° and 20°, respectively, and FIG. 1E also shows the reflection spectrum of the second CLC layer when the AOI is 0° and 20°, respectively. Referring to FIGS. 1D and 1E, as the AOI of the incident light increases from 0° to 20°, the reflection band of each of the first CLC layer and the second CLC layer may be blue-shifted, and the reflection efficiency of each of the first CLC layer and the second CLC layer may be decreased. Thus, the reflection band of the conventional broadband CLC device may be blue-shifted, and the reflection efficiency may be decreased.

In view of the limitations in conventional technologies, the present disclosure provides a reflective liquid crystal polarization hologram (“LCPH”) element or device configured to deflect a polychromatic light with high efficiency over a wide angle of incidence (“AOI”) range. In the present disclosure, the LCPH elements may include polarization volume hologram (“PVH”) elements and cholesteric liquid crystal (“CLC”) elements, etc. The LCPH elements may be fabricated based on various methods, such as holographic interference, direct writing, ink-jet printing, 3D printing, and various other forms of lithography. Thus, a “hologram” described herein is not limited to creation by holographic interference, or “holography.”

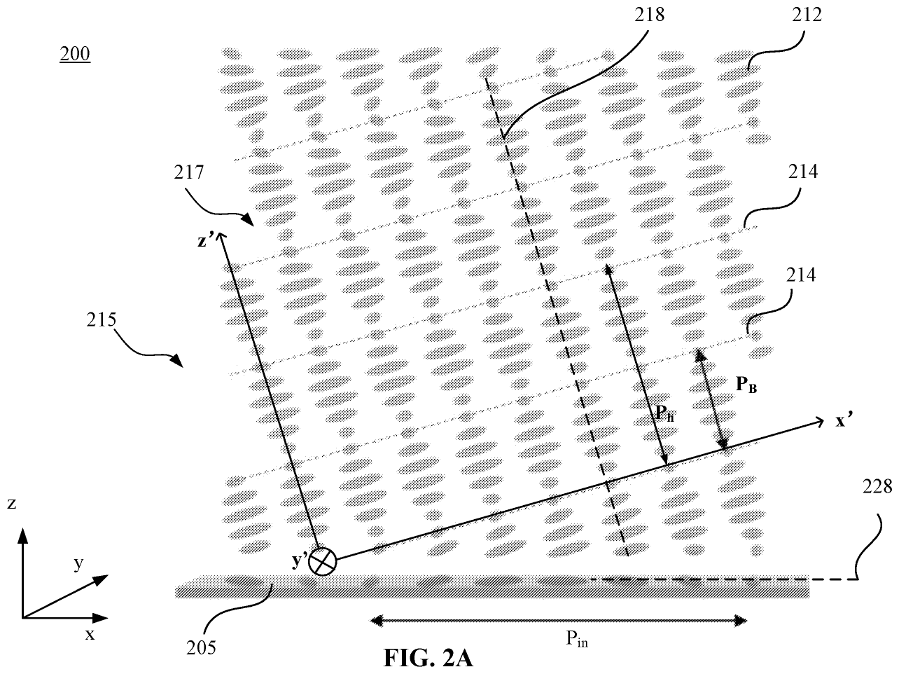

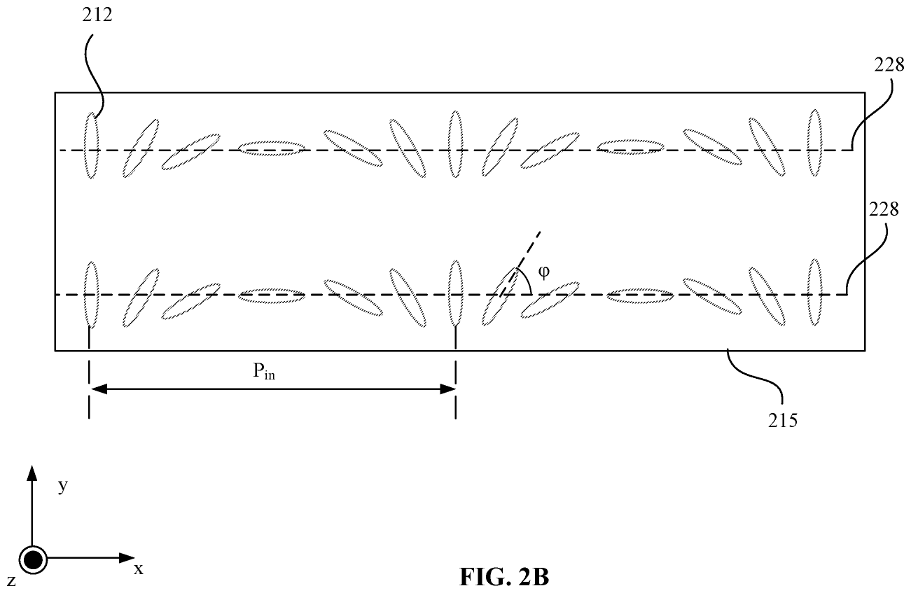

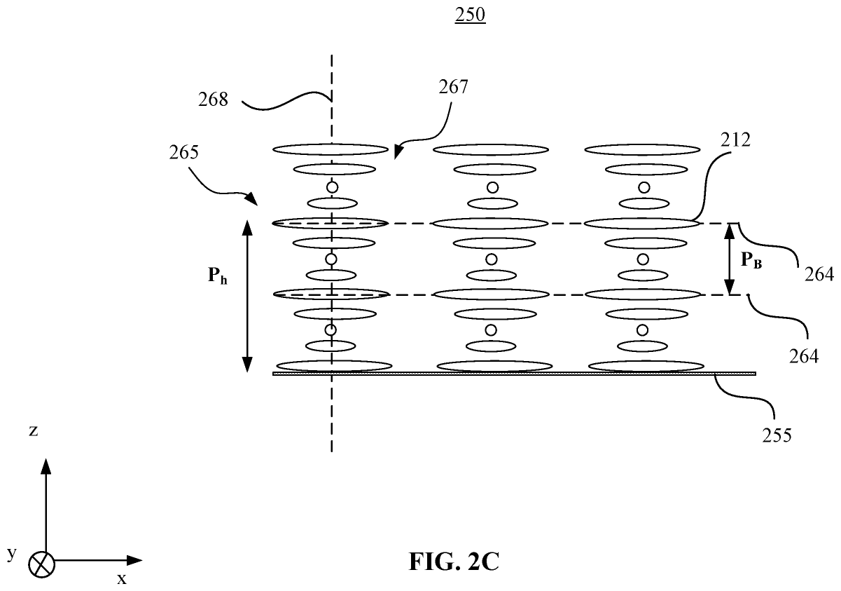

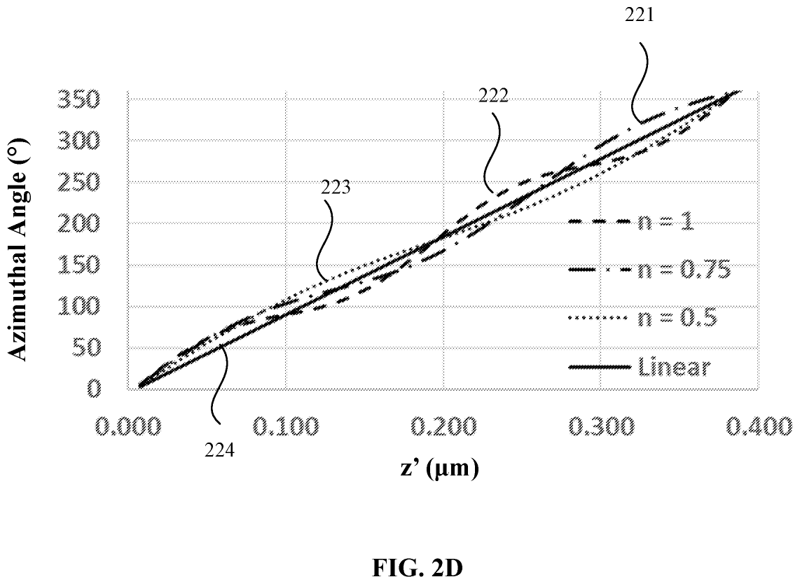

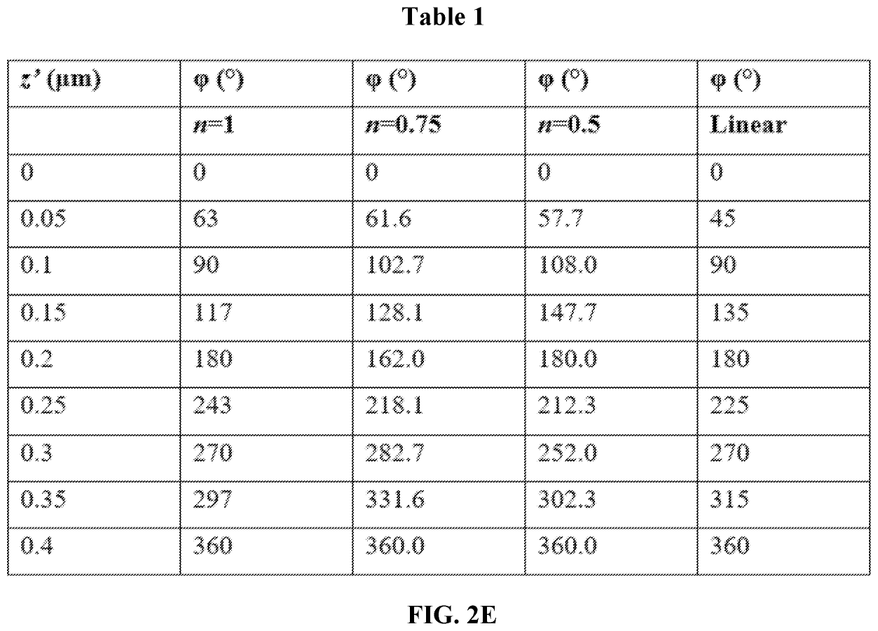

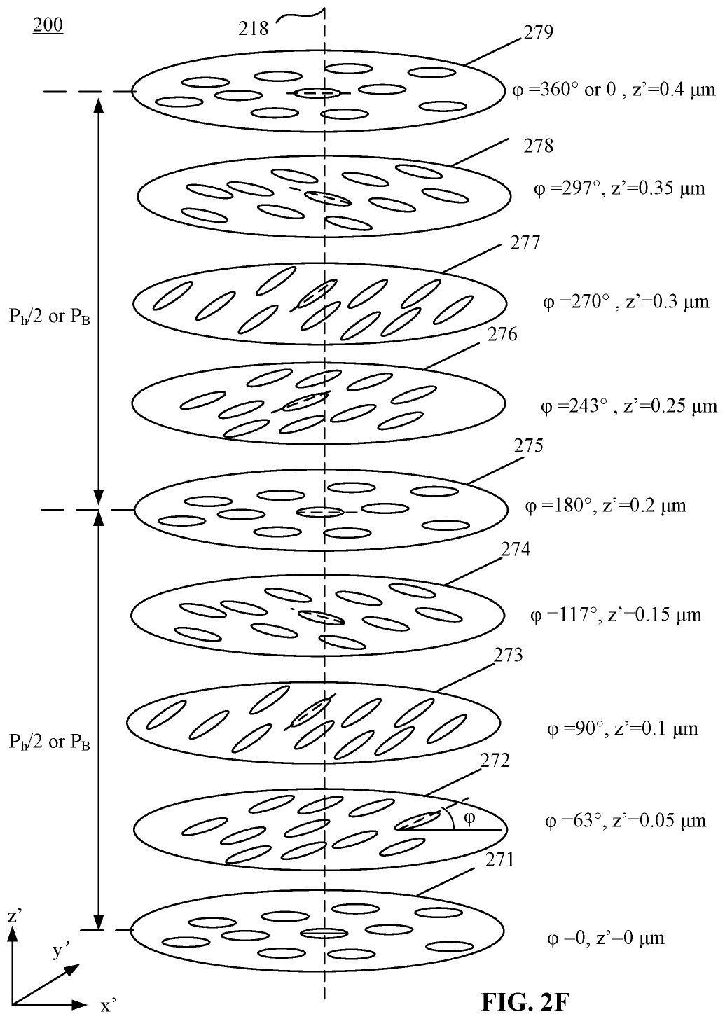

FIG. 2A illustrates a 3D view of an LCPH element 200, according to an embodiment of the present disclosure. FIG. 2B illustrates an x-y sectional view of the LCPH element 200 shown in FIG. 2A, according to an embodiment of the present disclosure. In the embodiment shown in FIG. 2A, the LCPH element 200 may be a reflective polarization volume hologram (“R-PVH”) element (also referred to as 200 for discussion purposes). The R-PVH element 200 may be configured to substantially reflect, via backward diffraction, a circularly polarized light having a predetermined handedness, with high efficiency (e.g., at or above 98%) over a wide AOI range. The R-PVH element 200 may also substantially transmit, with zero or negligible diffraction, a circularly polarized light having a handedness that is opposite to the predetermined handedness.

As shown FIG. 2A, the R-PVH element 200 may include an optically anisotropic film 215, which may be a thin layer of a birefringent material with intrinsic or induced (e.g., photo-induced) optical anisotropy, such as liquid crystals, liquid crystal polymers, or amorphous polymers, etc. In some embodiments, the birefringent material may include nematic LCs, twist-bend LCs, chiral nematic LCs, smectic LCs, ferroelectric LCs, smectic LCs, etc., or any combination thereof. In some embodiments, the birefringent material may have an induced chirality, e.g., the birefringent material may be doped with a chiral dopant. In some embodiments, the birefringent material may have an intrinsic molecular chirality, e.g., birefringent material may include chiral LC molecules, or molecules having one or more chiral functional groups. The R-PVH element 200 may be an active element or a passive element.

The optically anisotropic film 215 may include optically anisotropic molecules 212. An optic axis of the optically anisotropic film 215 may be configured with a 3D orientational pattern to provide a polarization selective optical response. The orientation of the optic axis of the optically anisotropic film 215 may be determined by local orientations of the elongated optically anisotropic molecules 212 or the elongated molecular units (e.g., small molecules or fragments of polymeric molecules) included in the optically anisotropic molecules 212. For discussion purposes, elongated optically anisotropic molecules (e.g., rod-like LC molecules, also referred to as 212 for discussion purposes) are used as examples for describing the 3D orientational pattern of the optic axis of the optically anisotropic film 215. The optically anisotropic film 215 may also be referred to as an R-PVH layer 215.

Referring to FIGS. 2A and 2B, the R-PVH element 200 may be configured to have nonlinear azimuthal angle variations of the LC molecules 212 along both a predetermined in-plane axis within a surface 205 of the R-PVH layer 215 and a helical axis 218 within the volume of the R-PVH layer 215, resulting in one or more secondary (or side) reflection bands in addition to a primary (or main) reflection band. The R-PVH element 200 may provide high reflection efficiency (e.g., greater than 98%) for the primary reflection band and the one or more secondary (or side) reflection bands over a large AOI range (e.g., −25° to 25°, −30° to 30°, −35° to 35°, −45° to 45°, −50° to 50°, −60° to 60°, etc.).

As shown in FIGS. 2A and 2B, the LC molecules 212 located in close proximity to the surface 205 (e.g., within an x-y plane) of the R-PVH layer 215 may be configured to have a non-uniform in-plane orientation pattern with an in-plane pitch (or a horizontal pitch) Pᵢₙ. The directors of the LC molecules 212 located in close proximity to the surface 205 may periodically or non-periodically rotate along at least one in-plane direction (or in-plane axis) 228 within the surface 205, as shown in FIG. 2B. Thus, the azimuthal angle of the LC molecules 212 located in close proximity to a surface 205 may vary periodically or non-periodically along the at least one in-plane direction 228. The azimuthal angle of the LC molecules 212 located in close proximity to the surface 205 of the R-PVH layer 215 may be defined as an angle of the LC director with respect to the predetermined in-plane direction 228 within the surface 205, e.g., an x-axis direction shown in FIG. 2A. The in-plane pitch Pᵢₙ may be defined as a distance along the predetermined in-plane direction 228 over which the azimuthal angles of the LC molecules 212 located in close proximity to the surface 205 vary by 180°. The in-plane pitch Pᵢₙ may be a constant in-plane pitch or a varying in-plane pitch. For discussion purposes, the in-plane pitch Pᵢₙ of the non-uniform in-plane orientation pattern formed at the surface 205 may also be referred to as the in-plane pitch Pᵢₙ of the R-PVH element 200.

The predetermined in-plane direction 228 within the surface 205 may be an in-plane linear direction, an in-plane radial direction, an in-plane circumferential (e.g., azimuthal) direction, or a combination thereof. For example, in some embodiments, the R-PVH layer 215 may be coupled with an alignment structure (not shown) at the surface 205, and the alignment structure may at least partially align the LC molecules 212 located in close proximity to the surface 205 to have the non-uniform in-plane orientation pattern. The alignment structure may include a polyimide layer, a photo-alignment material (“PAM”) layer, a plurality of nanostructures or microstructures, an alignment network, or any combination thereof.

For discussion purposes, FIGS. 2A and 2B show that the LC molecules 212 located in close proximity to the surface 205 rotate periodically in the predetermined in-plane direction 228 (e.g., the x-axis direction shown in FIGS. 2A and 2B) with a constant in-plane pitch Pᵢₙ. Such a non-uniform in-plane orientation pattern may be referred to as a periodic in-plane orientation pattern. In some embodiments, the LC molecules 212 located in close proximity to the surface 205 may be configured with another suitable non-uniform in-plane orientation pattern, such as a lens pattern with a varying in-plane pitch (e.g., a spherical lens pattern, a cylindrical lens pattern, an off-axis lens pattern, or a freeform lens pattern, etc.), or a lens array pattern, etc.

In some embodiments, over a single in-plane pitch Pᵢₙ of the in-plane orientation pattern, the LC molecules 212 located in close proximity to the surface 205 may be configured to have a nonlinear azimuthal angle variation along the predetermined in-plane direction 228. For discussion purposes, over the single in-plane pitch Pᵢₙ, a starting (or reference) point of the 180° variation of the azimuthal angle along the predetermined in-plane direction 228 may be defined as a point where the azimuthal angle of the LC molecule 212 is 0°. In some embodiments, over the single in-plane pitch Pᵢₙ of the in-plane orientation pattern, the azimuthal angle of the LC molecule 212 may be configured to vary nonlinearly with respect to a distance from the starting point (e.g., where the azimuthal angle is 0°) to a local point at which the LC molecule 212 is located along the predetermined in-plane direction 228. For discussion purposes, the distance from the starting point (e.g., where the azimuthal angle is 0°) to a local point at which the LC molecule 212 is located along the predetermined in-plane direction 228 may be referred to as an in-plane axis distance of the LC molecule 212.

In some embodiments, over the single in-plane pitch Pᵢₙ of the in-plane orientation pattern, the azimuthal angle of the LC molecule 212 located in close proximity to the surface 205 may vary nonlinearly with respect to an in-plane axis distance x (unit: μm) of the LC molecule 112, according to a nonlinear function φ(x)=180°*x/Pᵢₙ+f(A, n, x/Pᵢₙ), where φ is the azimuthal angle (unit: degree) of the LC molecule 212, and Pᵢₙ is the in-plane pitch (unit: m), which may be a constant value (with respect to x). The term 180°*x/Pᵢₙ is a linear function of x, Pᵢₙ meaning that this portion of the azimuthal angle changes with the in-plane axis distance x with a rate (or slope) of 180°/Pᵢₙ. The term f(A, n, x/Pᵢₙ) is a nonlinear function of the in-plane axis distance x, in which A is an amplitude parameter (which may be referred to as “amplitude” for simplicity of discussion) associated with the amplitude of the azimuthal angle variation introduced by the nonlinear function. The parameter n is a frequency parameter (which may also be referred to as “frequency” for simplicity of discussion) associated with a frequency of the azimuthal angle variation introduced by the nonlinear function. Thus, the nonlinear azimuthal angle variation with respect to the in-plane axis distance x is a combination of a linear variation and a nonlinear variation.

In some embodiments, the amplitude parameter A of the non-linear function may be a constant value with respect to the in-plane axis distance x. For example, the amplitude A may be configured as a positive value within the range of greater than 0° and smaller than or equal to 360°. In some embodiments, the frequency n of the nonlinear function may be a constant value with respect to the in-plane axis distance x. For example, the frequency n may be configured as a positive value within the range of greater than 0 and smaller than or equal to 1. The nonlinear term f(A, n, x/Pᵢₙ) may be any suitable nonlinear function, such as a quadratic function, a polynomial function, a rational function, an exponential function, a logarithmic function, a trigonometric function, or a combination thereof, etc. For example, in some embodiments, over the single in-plane pitch Pᵢₙ of the R-PVH element 200, the azimuthal angle of the LC molecule 212 located in close proximity to the surface 205 may be configured to vary according to a function of:

$$φ ( x ) = 180 ° * \frac{x}{{P}_{in}} + A * Sin ( n * 360 ° * \frac{x}{{P}_{in}} ) , where A * Sin ( n * 360 ° * \frac{x}{{P}_{in}} )$$

is an example of the nonlinear function

$$f ( A , n , \frac{x}{{P}_{in}} ) .$$

Referring back to FIG. 2A, within the volume of the R-PVH layer 215, the LC molecules 212 may be arranged in a plurality of helical structures 217 and a plurality of series of Bragg planes 214. The x-y-z coordinate system shown in FIG. 2A refers to a global coordinate system for the R-PVH element 200, whereas an x′-y′-z′ coordinate system shown in FIG. 2A refers to a local coordinate system for the helical structure 217. For discussion purposes, FIG. 2A shows that the Bragg planes 214 are within an x′-y′ plane, the helical axis 218 is along a z′-axis direction, and the Bragg planes 214 are substantially perpendicular to the helical axis 218.

A helical axis 218 of the helical structure 217 may be tilted with respect to the surface 205 of the R-PVH layer 215 (or with respect to the thickness direction of the R-PVH layer 215). The helical axis 218 may form an acute angle that is less than 450 with respect to the normal of the surface 205 or the thickness direction of the R-PVH layer 215 (e.g., a z-axis direction). In the helical structure 217, the directors of the LC molecules 212 may continuously rotate around the helical axis 218 in a predetermined rotation direction, e.g., clockwise direction or counter-clockwise direction. Accordingly, the helical structure 217 may exhibit a handedness, e.g., right handedness or left handedness.

The LC molecules 212 having a first same orientation (e.g., same first tilt angle and same first azimuthal angle) may form a first series of slanted and parallel refractive index planes (i.e., a first series of Bragg planes) 214 periodically distributed within the volume of the R-PVH layer 215. Although not labeled, the LC molecules 212 with a second same orientation (e.g., same second tilt angle and same second azimuthal angle) different from the first same orientation may form a second series of slanted and parallel refractive index planes (i.e., a second series of Bragg planes) 214 periodically distributed within the volume of the R-PVH layer 215. Different series of Bragg planes may be formed by the LC molecules 212 having different orientations. In the same series of Bragg planes, the LC molecules 212 may have the same orientation, and the refractive index may be the same. Different series of Bragg planes may correspond to different refractive indices. When the number of the Bragg planes (or the thickness of the R-PVH layer 215) increases to a sufficient value, Bragg diffraction may be established according to the principles of volume gratings. The distance between adjacent Bragg planes 214 of the same series may be referred to as a Bragg period P_{B}. In the embodiment shown in FIG. 2A, the Bragg planes 214 may form an acute angle with respect to the surface 205 of the R-PVH layer 215.

As the directors of the LC molecules 212 continuously rotate around the helical axis 218 in the predetermined rotation direction, the azimuthal angles of the LC molecules 212 within the volume of the R-PVH layer 215 may exhibit a continuous periodic variation along the helical axis 218. The azimuthal angle of the LC molecule 212 located within the volume of the R-PVH layer 215 may be defined as an angle of the LC director with respect to a predetermined in-plane direction within the Bragg plane 214, e.g., an x′-axis in FIG. 2A. A helical pitch Pₕ of the helical structures 217 may be defined as a distance along the helical axis 218 over which the orientation of the LC directors rotate by 360° or the azimuthal angle of the LC molecules 212 vary by 360°. The helical pitch Pₕ is presumed to be constant across the R-PVH layer 215. The Bragg period P_{B} may be smaller than the helical pitch Pₕ. For discussion purpose, FIG. 2A shows that the Bragg period P_{B} is half of the helical pitch Pₕ. In some embodiments, although not shown, the Bragg period P_{B} may be smaller than or greater than half of the helical pitch Pₕ.

In some embodiments, over the single helical pitch Pₕ of the helical structure 217, the LC molecules 212 located within the volume of the R-PVH layer 215 may be configured to have a nonlinear azimuthal angle variation along the helical axis 218. For discussion purposes, a local point at the helical axis 218 where the azimuthal angle of the LC molecule 212 is 0° may be defined as a starting point of the 360° variation of azimuthal angle along the helical axis 218. Over the single helical pitch Pₕ of the helical structure 217, the azimuthal angle of the LC molecule 212 may be configured to vary nonlinearly with respect to a distance from the starting point (e.g., where the azimuthal angle is 0°) to a local point at which the LC molecule 212 is located along the helical axis 218. For discussion purposes, over the single helical pitch Pₕ of the helical structure 217, the distance from the starting point (e.g., where the azimuthal angle is 0°) to a local point at which the LC molecule 212 is located along the helical axis 218 may be referred to as an out-of-plane axis distance of the LC molecule 212.

In some embodiments, over the single helical pitch Pₕ of the helical structure 217, the azimuthal angle of the LC molecule 212 may vary according to a function

$$φ ( {z}^{′} ) = 180 ° * \frac{{z}^{′}}{{P}_{B}} + f ( A , n , \frac{{z}^{′}}{{P}_{B}} ) ,$$

where φ is the azimuthal angle of the LC molecule 212, z′ is an out-of-plane axis distance of the LC molecule 112, and P_{B} is the Bragg period. The term

$$180 ° * \frac{{z}^{′}}{{P}_{B}}$$

is a linear function of z′, the term

$$f ( A , n , \frac{{z}^{′}}{{P}_{B}} )$$

is a nonlinear function of z′, A is an amplitude parameter of the non-linear function, and n is a frequency parameter of the non-linear function. In some embodiments, the amplitude A of the nonlinear function may be configured as a positive value within the range of greater than 0° and smaller than or equal to 360°, and the frequency n of the non-linear function may be configured as a positive value within the range of greater than 0 and smaller than or equal to 1. The nonlinear function

$$f ( A , n , \frac{{z}^{′}}{{P}_{B}} )$$

may be any suitable nonlinear function, such as a quadratic function, a polynomial function, a rational function, an exponential function, a logarithmic function, a trigonometric function, or a combination thereof, etc.

FIG. 2C illustrates an x-z sectional view of an LCPH element 250, according to an embodiment of the present disclosure. In the embodiment shown in FIG. 2C, the LCPH element 250 may be a non-slanted CLC element (also referred to as 250 for discussion purposes) configured to substantially reflect a circularly polarized light having a predetermined handedness, and substantially transmit a circularly polarized light having a handedness that is opposite to the predetermined handedness. The CLC element 250 may include an optically anisotropic film (referred to as a CLC layer) 265 that is similar to the R-PVH layer 215 shown in FIG. 2A. The LC molecules 212 disposed in close proximity to a surface 255 (e.g., within an x-y plane) of the CLC layer 265 may be configured to have a uniform in-plane orientation pattern.

Within the volume of the CLC layer 265, the LC molecules 212 may be arranged in a plurality of helical structures 267 and a plurality of series of Bragg planes 264. A helical axis 268 of the helical structures 267 may extend in a thickness direction of the CLC layer 265, and may be substantially perpendicular to the surface 255 of the CLC layer 265. The Bragg planes 264 formed within the volume of the CLC layer 265 may be parallel with the surface 255 of the CLC layer 265. FIG. 2C shows that the Bragg planes 264 are located within an x-y plane, and the helical axis 268 extends in a z-axis direction. The azimuthal angle of the LC molecule 212 located with the volume of the CLC layer 265 may be defined as an angle of the LC director with respect to a predetermined in-plane direction (e.g., an x-axis direction in FIG. 2C) within the Bragg plane 264. The helical pitch Pₕ is presumed to be constant across the CLC layer 265. In the CLC element 250, the coordinate system of the CLC element 250 may coincide with the coordinate system of the helical structures 267.

Similar to the R-PVH element 200 shown in FIG. 2A, in the CLC element 250 shown in FIG. 2C, over a single helical pitch Pₕ of the helical structure 267, the LC molecules 212 may be configured with a nonlinear azimuthal angle variation along the helical axis 268. For example, the azimuthal angle of the LC molecule 212 may vary according to a function

$$φ ( z ) = 180 ° * \frac{z}{{P}_{B}} + f ( A , n , \frac{z}{{P}_{B}} ) ,$$

where φ is the azimuthal angle of the LC molecule 212, z is an out-of-plane axis distance of the LC molecule 112, and P_{B} is the Bragg period. Descriptions of the nonlinear azimuthal angle variation of the LC molecules 212 along the helical axis 268 can refer to the above corresponding descriptions rendered in connection with FIG. 2A. The nonlinear azimuthal angle variation of the LC molecules 212 along the helical axis 268 of the CLC element 250 may result in one or more secondary reflection bands in addition to a primary reflection band. The CLC element 250 may provide high reflection efficiency (e.g., greater than 98%) for the primary reflection band and the one or more secondary reflection bands over a large AOI range.

FIGS. 2D-2F illustrate various nonlinear azimuthal angle variations of the LC molecule 212 over the single helical pitch Pₕ of the helical structures 218 in the R-PVH element 200, according to various embodiments of the present disclosure. It is noted that the CLC element 250 may also be configured with similar nonlinear azimuthal angle variations of the LC molecule 212 over the single helical pitch Pₕ of the helical structures 268.

FIG. 2D illustrates simulation results showing various nonlinear relationships between an azimuthal angle φ of the LC molecule 212 and an out-of-plane axis distance z′ (shown in FIG. 2A) of the LC molecule 212, over the single helical pitch Pₕ of the helical structures 218 formed in the R-PVH element 200, according to various embodiments of the present disclosure. As shown in FIG. 2D, the horizontal axis represents an out-of-plane axis distance z′ (unit: m) of the LC molecule 212, and the vertical axis represents an azimuthal angle φ (unit: degrees) of the LC molecule 212. In the simulations, over a single helical pitch Pₕ of the helical structure 217, the azimuthal angle φ of the LC molecule 212 may vary according to a function

$$φ ( {z}^{′} ) = 180 ° * \frac{{z}^{′}}{{P}_{B}} + A * Sin ( n * 360 ° * \frac{{z}^{′}}{{P}_{B}} ) , where 180 ° * \frac{{z}^{′}}{{P}_{B}}$$

is a linear function of the out-of-plane axis distance z′,

$$A * Sin ( n * 360 ° * \frac{{z}^{′}}{{P}_{B}} )$$

is an example of the nonlinear function

$$f ( A , n , \frac{{z}^{′}}{{P}_{B}} ) , A = 18 ° , and {P}_{B} = 0.2 μ m .$$

A curve 221 in FIG. 2D shows a nonlinear relationship between the azimuthal angle φ of the LC molecule 212 and the out-of-plane axis distance z′ of the LC molecule 212 when n=1. A curve 222 shows a nonlinear relationship between the azimuthal angle φ of the LC molecule 212 and the out-of-plane axis distance z′ of the LC molecule 212 when n=0.75. A curve 223 shows a nonlinear relationship between the azimuthal angle φ of the LC molecule 212 and the out-of-plane axis distance z′ of the LC molecule 212 when n=0.5. A straight line 224 shows the linear term

$$180 ° * \frac{{z}^{′}}{{P}_{B}} .$$

The linear term or the straight line 224 also represents a linear relationship between an azimuthal angle φ of the LC molecules 112 and an axis distance z′ of the LC molecules 112 over a single helical pitch Pₕ of the helical structures 117 formed in the conventional R-PVH element 150 shown in FIG. 1B. The straight line 224 has a constant slope of 180°/P_{B}, indicating that over a single helical pitch Pₕ of the helical structures 117 formed in the conventional R-PVH element 150, the azimuthal angle φ of the LC molecules linearly increases as the out-of-plane axis distance z′ of the LC molecules 112 increases. Each of the curves 221-223 is shown as a wavy line, which oscillates around the straight line 224, indicating that over the single helical pitch Pₕ of the helical structures 218, the azimuthal angle φ of the LC molecules 212 nonlinearly increases as the out-of-plane axis distance z′ of the LC molecules 212 increases. The oscillation around the straight line 224 may vary with the frequency n of the nonlinear term. The nonlinear azimuthal angle variation is a combined result of the linear term and the nonlinear term as indicated in the function of

$$φ ( {z}^{′} ) = 180 ° * \frac{{z}^{′}}{{P}_{B}} + A * Sin ( n * 360 ° * \frac{{z}^{′}}{{P}_{B}} ) .$$

FIG. 2E illustrates a table showing the simulated azimuthal angles S of the LC molecules 212 for a series of out-of-plane axis distances (z′=0.25*P_{B}, 0.5*P_{B}, 0.75*P_{B}, P_{B}, 1.25*P_{B}, 1.5*P_{B}, 1.75*P_{B}, and 2*P_{B}) and a series of frequencies (n=1, 0.75, and 0.5), over the single helical pitch Pₕ of the R-PVH element 200, according to various embodiments of the present disclosure. As shown in Table 1, over the single helical pitch Pₕ of the helical structures 218, the azimuthal angle φ of the LC molecules 212 nonlinearly increases as the out-of-plane axis distance z′ of the LC molecules 212 increases. The last column (marked as “Linear”) of the table shown in FIG. 2E also shows the calculated azimuthal angles 6 of the LC molecules 112 for a series of axis distances (z′=0.25*P_{B}, 0.5*P_{B}, 0.75*P_{B}, P_{B}, 1.25*P_{B}, 1.5*P_{B}, 1.75*P_{B}, 2*P_{B}), over the single helical pitch Pₕ of the helical structures 118 formed in the conventional R-PVH element 150 shown in FIG. 1B.

FIG. 2F illustrates a 3D exploded view of a portion of the R-PVH element 200 shown in FIG. 2A, showing a nonlinear azimuthal angle variation of the LC molecules 212 over a single helical pitch Pₕ of the helical structure 217 when n=1. For discussion purposes, FIG. 2F shows that over a single helical pitch Pₕ of the helical structure 217, the LC molecules 212 are organized in nine successive sub-layers (or Bragg planes) 271-279 that are equally spaced from one another along the helical axis 218. In the same sub-layer, the LC directors (represented by dashed lines) may be oriented in the same direction, and across different sub-layers, the LC directors (represented by dashed lines) may be oriented in different directions. Over the single helical pitch Pₕ of the helical structure 217, the starting point of the 360° variation of the azimuthal angle along the helical axis 218 may be at the sub-layer 271 where the azimuthal angle φ is 0°. FIG. 2F shows that when the axis distances z′ of the sub-layer 272-279 are 0.05 m, 0.1 m, 0.15 m, 0.2 m, 0.25 m, 0.3 m, 0.35 m, and 0.4 m, respectively, the corresponding azimuthal angles φ of the LC molecules 212 are 63°, 90°, 117°, 180°, 243°, 270°, 297°, and 360°, respectively.

The nonlinear azimuthal angle variation of the LC molecules 212 in the R-PVH element 200 or the CLC element 250 may result in one or more secondary (or side) reflection bands in addition to a primary reflection band. In some embodiments, the nonlinear azimuthal angle variation of the LC molecules 212 in the R-PVH element 200 or the CLC element 250 may result in at least two series of Bragg planes having different Bragg periods within the volume of the PVH element 200 or the CLC element 250, such as a first series of Bragg planes (e.g., 214) having a first Bragg period, a second series of Bragg planes (not shown in FIG. 2A) having a second, different, Bragg period, and so on. In some embodiments, due to the nonlinear azimuthal angle variation of the LC molecules 212 in the R-PVH element 200, the LC molecules 212 within the R-PVH element 200 may have in-plane orientation patterns within film planes of the R-PVH element 200. The in-plane orientation patterns within film planes of the R-PVH element 200 may have at least one in-plane pitch that is different from the in-plane pitch Pᵢₙ of the in-plane orientation pattern formed at the surface 205 of the R-PVH element 200.

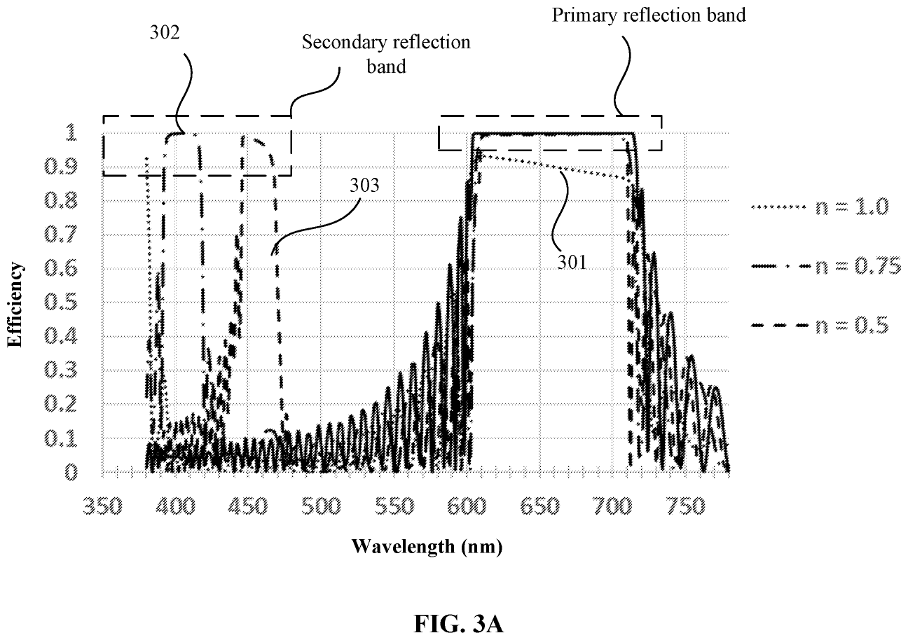

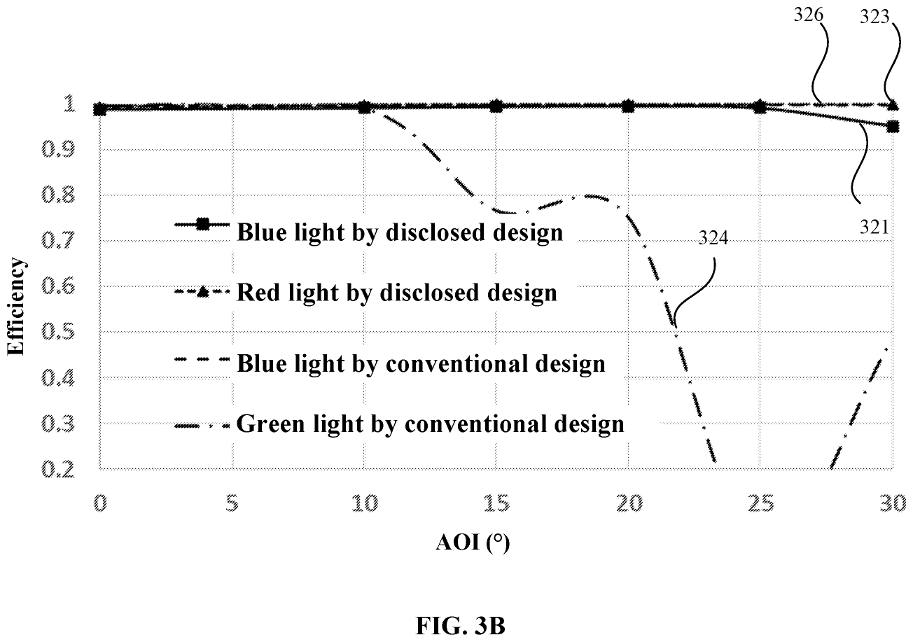

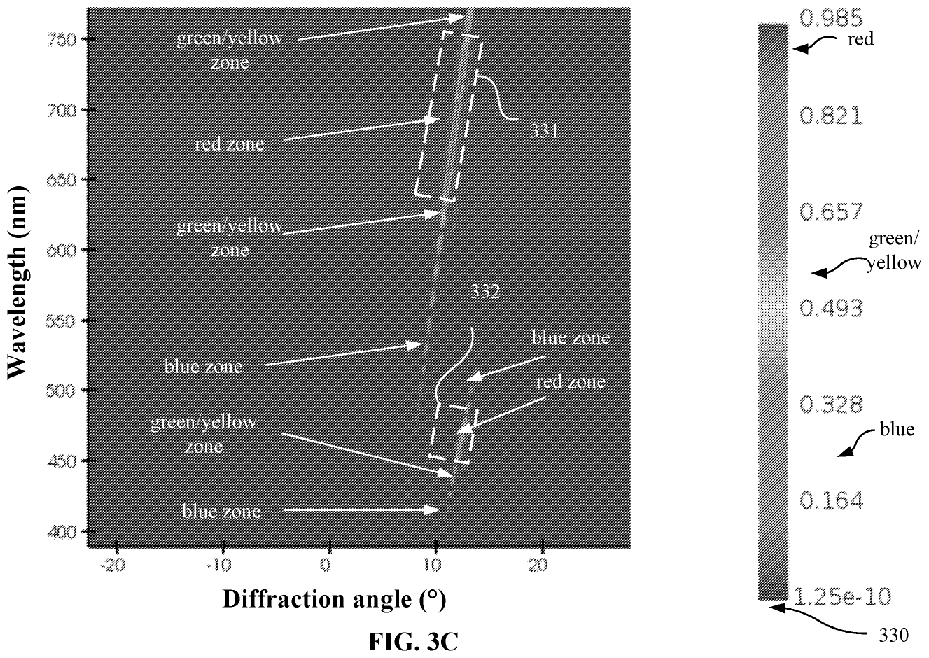

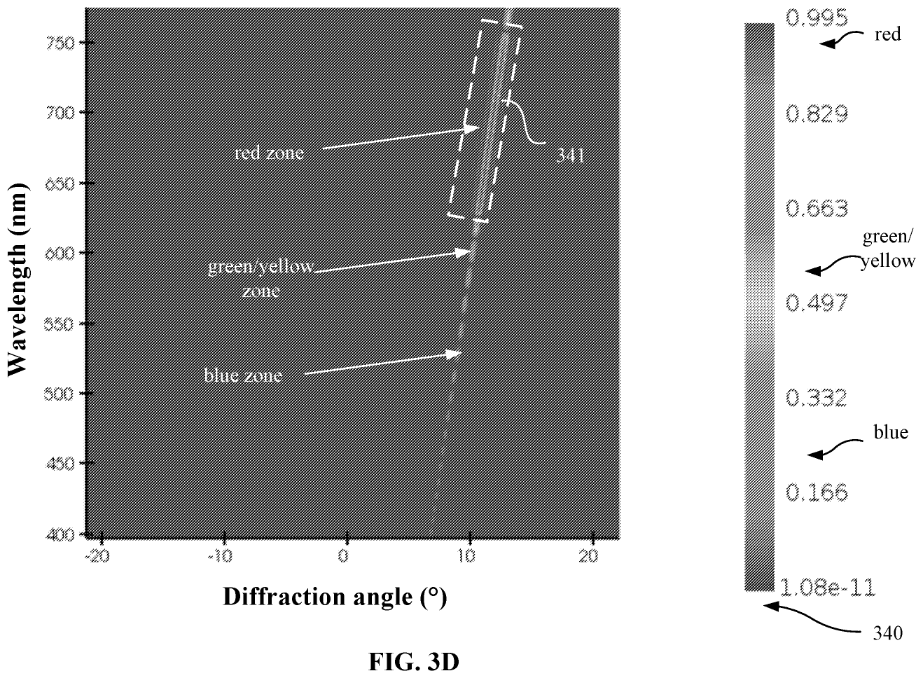

FIG. 3A illustrates simulation results showing relationships between a reflection efficiency and a wavelength of an incident light of the CLC element 250 shown in FIG. 2C, according to various embodiments of the present disclosure. In the simulation, over a single helical pitch Pₕ of the helical structure 267 in the CLC element 250, the azimuthal angle (p of the LC molecule 212 varies according to the function

$$φ ( z ) = 180 ° * \frac{z}{{P}_{B}} + A * Sin ( n * 360 ° * \frac{z}{{P}_{B}} ) ,$$

where A=18°, P_{B}=0.2 μm, and the birefringent material in the CLC element 250 has a birefringence of 0.35.

As shown in FIG. 3A, the horizontal axis represents a wavelength (unit: m) of an incident light (or wavelength of incidence), and the vertical axis represents normalized reflection efficiency. A curve 301 shows a relationship between the normalized reflection efficiency and the wavelength of incidence when n=1. A curve 302 shows a relationship between the normalized reflection efficiency and the wavelength of incidence when n=0.75. A curve 303 shows a relationship between the normalized reflection efficiency and the wavelength of incidence when n=0.5. The curves 301, 302, and 303 show that when the LC molecules 212 are configured with a nonlinear azimuthal angle variation over the single helical pitch Pₕ, the CLC element 250 exhibits a secondary reflection band in addition to a primary reflection band.

The primary reflection band and the secondary reflection band may be separated from one another. The primary reflection band may have a relatively broad bandwidth, and the secondary reflection band may have a relatively narrow bandwidth. Both the primary reflection band and the secondary reflection band may have substantially high reflection efficiency, e.g., greater than 95%. For discussion purposes, FIG. 3A shows that the primary reflection band is the red wavelength range, and the secondary reflection band is the blue wavelength range. Thus, the CLC element 250 may reflect both red light and the blue light with a substantially high reflection efficiency. FIG. 3A also shows that when the frequency n decreases from 1 to 0.5, the separation distance between the primary reflection band and the secondary reflection band may decrease. That is, when the frequency n gradually decreases, the secondary reflection band may gradually approach the primary reflection band.

Referring to FIG. 1C and FIG. 3A, the primary reflection band of the CLC element 250 shown in FIG. 3A and the reflection band of the CLC layer (that reflects the red light) shown in FIG. 1C may have a substantially same bandwidth (e.g., about 100 nm) and a substantially high reflection efficiency (e.g., greater than 98%). That is, although the nonlinear azimuthal angle variation of the LC molecules 212 along the helical axis 268 introduces the secondary reflection band, the bandwidth and the reflection efficiency of the primary reflection band may be substantially maintained.

Referring to FIG. 1D and FIG. 3A, to provide a reflection band including two different wavelength ranges, a conventional CLC layer shown in FIG. 1D may use a birefringent material with a substantially high birefringence (e.g., 0.5 for including blue and green wavelength ranges), while the disclosed CLC layer 265 may use a birefringent material with a low birefringence (e.g., 0.35 for including both blue and red wavelength ranges). Thus, compared to the conventional CLC layer configured with the linear azimuthal angle variation shown in FIG. 1D, the disclosed CLC element 250 may be fabricated based on a wide range of birefringent materials since materials with high birefringence are limited and materials with low birefringence are more widely available, and the stability and the response time of the disclosed CLC element 250 may be improved.

In the present discourse, the CLC element 250 including a single CLC layer 265 shown in FIG. 2C may provide a high reflection efficiency for both the primary reflection band and the secondary reflection band over a large angle of incidence (“AOI”) range. FIG. 3B illustrates simulation results showing relationships between a reflection efficiency and an AOI of a red light and a blue light of the CLC element 250 shown in FIG. 2C, according to an embodiment of the present disclosure. As shown in FIG. 3B, the horizontal axis represents angle of incidence (“AOI”), and the vertical axis represents normalized reflection efficiency. In the simulation, over the single helical pitch Pₕ of the helical structure 267 in the CLC element 250, the azimuthal angle (p of the LC molecule 212 varies according to a function

$$φ ( z ) = 180 ° * \frac{z}{{P}_{B}} + A * Sin ( n * 360 ° * \frac{z}{{P}_{B}} ) ,$$

where A=18°, n=0.75, P_{B}=0.2 μm, and the birefringent material in the CLC element 250 has a birefringence of 0.35.

As shown in FIG. 3B, a curve 321 shows a relationship between the normalized reflection efficiency of the CLC element 250 and the AOI of a blue incident light, and a curve 323 shows a relationship between the normalized reflection efficiency of the CLC element 250 and the AOI of a red incident light. The curves 321 and 323 show that as the AOI increases from 0° to 30°, the CLC element 250 provides a substantially high reflection efficiency (e.g., greater than 98%) for both the blue incident light and the red incident light. That is, as the AOI increases from 0° to 30°, the CLC element 250 may substantially maintain the high reflection efficiency (e.g., greater than 98%) over the entire AOI range (e.g., 30°) for both the blue incident light and the red incident light.

FIG. 3B also illustrates simulation results showing relationships between a reflection efficiency and an AOI of a blue light and a green light of the conventional CLC layer configured with the linear azimuthal angle variation shown in FIG. 1D. A curve 326 shows a relationship between the normalized reflection efficiency of the conventional CLC layer and the AOI of a blue incident light, and a curve 324 shows a relationship between the normalized reflection efficiency of the conventional CLC layer and the AOI of a green incident light. FIG. 3B shows that the curve 326 substantially overlaps with the curve 323. The curve 326 shows that as the AOI increases from 0° to 30°, the conventional CLC layer shown in FIG. 1D provides a substantially high reflection efficiency (e.g., greater than 98%) for the blue incident light. The curve 324 shows that for the green incident light, the conventional CLC layer shown in FIG. 1D provides a substantially high (e.g., greater than 98%) reflection efficiency when the AOI is within the range of 0° to 10°. However, the reflection efficiency is significantly reduced when the AOI increases from 10° to 30°. That is, the conventional CLC layer shown in FIG. 1D may not maintain the high reflection efficiency (e.g., greater than 98%) over the entire AOI range (e.g. 30°) for both the blue incident light and the green incident light.

FIG. 3C illustrates simulation results showing a relationship between the reflection efficiency (or diffraction efficiency) and the wavelength of an incident light (or an incidence wavelength) of the R-PVH element 200 shown in FIGS. 2A and 2B, according to an embodiment of the present disclosure. In the simulation, the azimuthal angle (p of the LC molecule 212 may be configured to vary according to the function

$$φ ( {z}^{′} ) = 180 ° * \frac{{z}^{′}}{{P}_{B}} + A * Sin ( n * 360 ° * \frac{{z}^{′}}{{P}_{B}} )$$

over the single helical pitch Pₕ. The amplitude A of the non-linear function A*

$$Sin ( n * 360 ° * \frac{{z}^{′}}{{P}_{B}} )$$

and the Bragg period P_{B} are presumed to be constant values, e.g., A=18°, and P_{B}=0.2 μm. The value of the frequency n may be configured, such that the R-PVH element 200 may provide a secondary reflection band in addition to a primary reflection band. Through configuring the nonlinear azimuthal angle variation of the LC molecule 212, the R-PVH element 200 may provide a high reflection efficiency over a large AOI range in the primary and reflection band and the secondary reflection band.

In comparison, FIG. 3D illustrates simulation results showing a relationship between the reflection efficiency (or diffraction efficiency) and the wavelength of an incident light (or an incidence wavelength) of a conventional R-PVH element (e.g., the R-PVH element 150 shown in FIG. 1). In FIGS. 3C and 3D, the vertical axis represents a wavelength of incidence (unit: m), and the horizontal axis represents diffraction angle (unit: degree). A color bar 330 or 340 (from blue (0) to red (1)) is shown to represent the normalized reflection efficiency. On the color bar 330 or 340, the blue color denotes a lower normalized reflection efficiency (between 0 and 0.3), and the red color denotes a higher normalized reflection efficiency (between 0.8 and 1). In the middle of the color bar is the green/yellow color representing medium normalized reflection efficiency between 0.3 and 0.8. As the color gradually changes from the blue to the red, the normalized reflection efficiency gradually increases from 0 to 1.

Referring to FIG. 3C, the R-PVH element 200 shown in FIGS. 2A and 2B may exhibit a secondary reflection band 332 in addition to a primary reflection band 331, providing a substantially high reflection efficiency for both the primary reflection band 331 and the secondary reflection band 332 over a large AOI range. The primary reflection band 331 and the secondary reflection band 332 may be separated from one another. The primary reflection band 331 may have a relatively broad bandwidth, and the secondary reflection band 332 may have a relatively narrow bandwidth. Both the primary reflection band 331 and the secondary reflection band 332 may have a substantially high reflection efficiency (or diffraction efficiency), e.g., greater than 95%. For discussion purpose, FIG. 3C shows that the primary reflection band 331 includes the red wavelength range, the secondary reflection band 332 includes the blue wavelength range. Thus, the R-PVH element 200 may reflect, via backward diffraction, both the red light and the blue light with a substantially high reflection efficiency (or diffraction efficiency), e.g., greater than 98%. Referring to FIG. 3D, the conventional R-PVH element (e.g., the R-PVH element 150 shown in FIG. 1B) may provide a single reflection band 341 that includes the red wavelength range, reflecting the red light with a substantially high reflection efficiency (e.g., greater than 98%).

In some embodiments, the nonlinear azimuthal angle variation of the LC molecules 212 over a single helical pitch Pₕ in the R-PVH element 200 shown in FIGS. 2A and 2B or the CLC element 250 shown in FIG. 2C may be configured, such that the R-PVH element 200 or the CLC element 250 may exhibit two extra secondary (or side) reflection bands in addition to a primary reflection band. The R-PVH element 200 or the CLC element 250 may provide a high reflection efficiency for the primary reflection band and the two secondary reflection bands over a large AOI range.

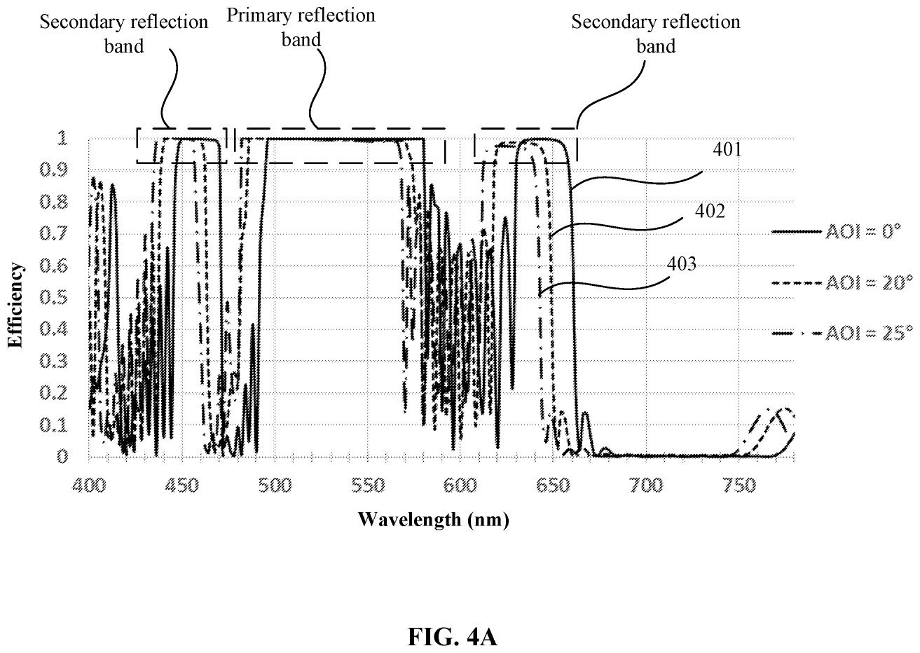

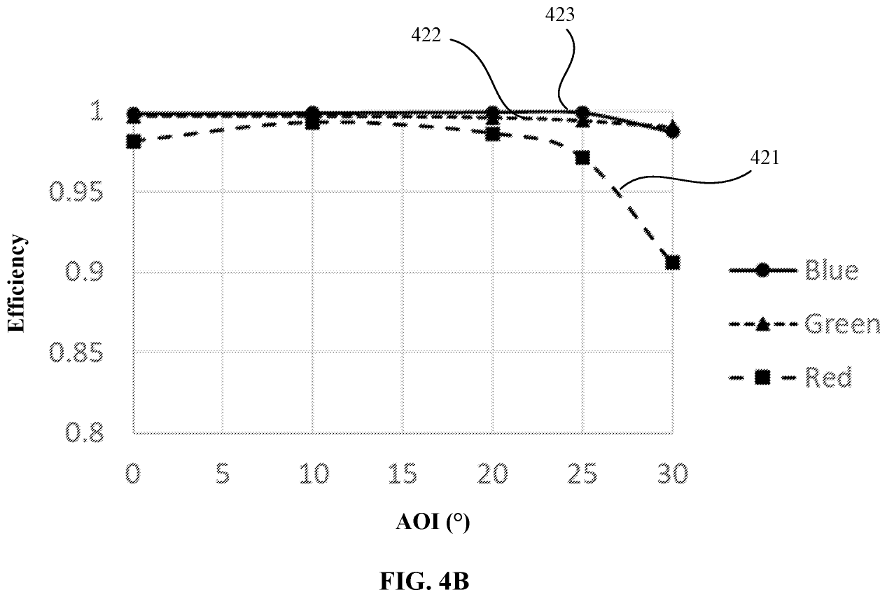

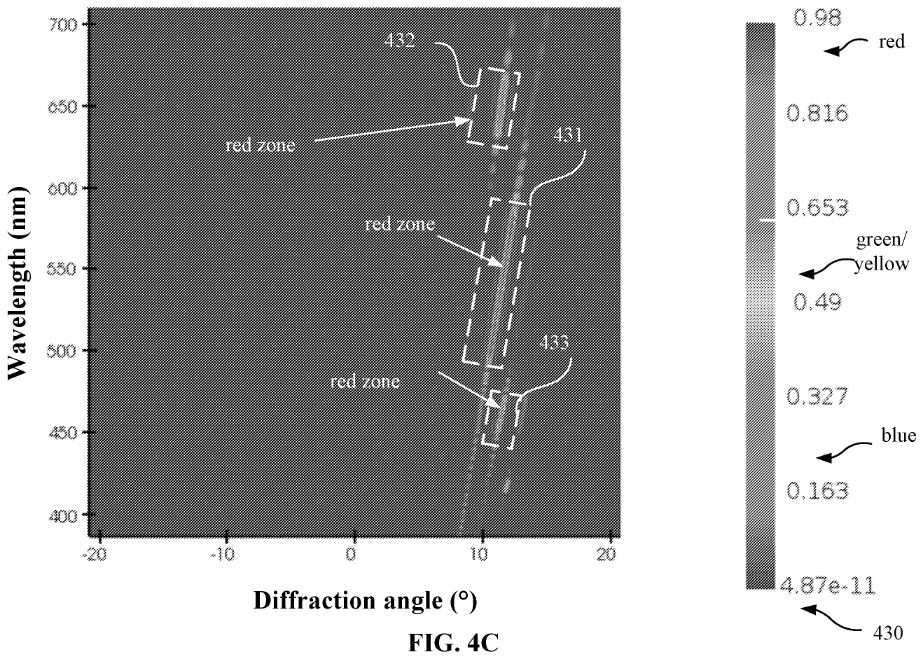

FIG. 4A illustrates simulation results showing relationships between a reflection efficiency and a wavelength of an incident light of the CLC element 250 shown in FIG. 2C for various angles of incidence, according to an embodiment of the present disclosure. As shown in FIG. 4A, the horizontal axis represents a wavelength (unit: m) of an incident light (or wavelength of incidence), and the vertical axis represents normalized reflection efficiency. In the simulation, the azimuthal angle φ of the LC molecule 212 may be configured to vary according to the function

$$φ ( z ) = 180 ° * \frac{z}{{P}_{B}} + A * Sin ( n * 360 ° * \frac{z}{{P}_{B}} )$$

over the single helical pitch Pₕ. The amplitude A of the nonlinear function

$$A * Sin ( n * 360 ° * \frac{z}{{P}_{B}} )$$

and the Bragg period P_{B} are presumed to be constant values, e.g., A=18°, and P_{B}=0.2 μm. The value of the frequency n may be configured, such that the CLC element 250 may provide a primary reflection band and two additional secondary reflection bands, with a high reflection efficiency over a large AOI range.

A curve 401 shows a relationship between the normalized reflection efficiency and the wavelength of incidence when AOI=0°. A curve 402 shows a relationship between the normalized reflection efficiency and the wavelength of incidence when AOI=20°. A curve 403 shows a relationship between the normalized reflection efficiency and the wavelength of incidence when AOI=25°. The curves 401, 402, and 403 each show that the CLC element 250 exhibits a primary reflection band, and two secondary reflection bands. The primary reflection band and the two secondary reflection bands may be separated from one another, and the two secondary reflection bands may be located at two sides of the primary reflection band. The primary reflection band may have a relatively broad bandwidth, and the secondary reflection band may have a relatively narrow bandwidth.

For discussion purposes, FIG. 4A shows that the primary reflection band includes the green wavelength range, and the two secondary reflection bands include the blue wavelength range and the red wavelength range, respectively. Thus, the CLC element 250 including the single CLC layer 265 may function as a broadband CLC device covering the visible wavelength range. In some embodiments, although not shown, the primary reflection band may be configured to include a suitable wavelength range other than the green wavelength range, and the two secondary reflection bands may be configured to include suitable wavelength ranges other than the blue wavelength range and the red wavelength range.

FIG. 4B illustrates simulation results showing relationships between a reflection efficiency and an AOI of blue, green, and red incident lights of the CLC element 250 shown in FIG. 4A, according to an embodiment of the present disclosure. As shown in FIG. 4B, the horizontal axis represents angle of incidence (“AOI”), and the vertical axis represents normalized reflection efficiency. A curve 421 shows a relationship between the normalized reflection efficiency and the AOI of a red incident light. A curve 422 shows a relationship between the normalized reflection efficiency and the AOI of a green incident light. A curve 423 shows a relationship between the normalized reflection efficiency and the AOI of a blue incident light.

The curves 421, 422, and 423 show that the CLC element 250 provides a substantially high reflection efficiency (e.g., greater than 98%) for the red, green, and blue incident lights over an AOI range of about 25°. The curves 421, 422, and 423 also show that, as the AOI further increases from 25° to 30°, the reflection efficiency of the CLC element 250 for the blue incident light is reduced to about 9°%, while the high reflection efficiency of the CLC element 250 for the red and green incident lights is substantially maintained (e.g., greater than 98%). Overall, the CLC element 250 including the single CLC layer 265 may function as a broadband CLC device that provides A substantially high reflection efficiency (e.g., greater than 98%) for the visible wavelength range over a large AOI range of 25°.

FIG. 4C illustrates simulation results showing a relationship between the reflection efficiency (or diffraction efficiency) and the wavelength of an incident light (or an incidence wavelength) of the R-PVH element 200 shown in FIGS. 2A and 2B, according to an embodiment of the present disclosure. In the simulation, the azimuthal angle φ of the LC molecule 212 may be configured to vary according to the function

$$φ ( {z}^{′} ) = 180 ° * \frac{{z}^{′}}{{P}_{B}} + A * Sin ( n \cdot 360 ° * \frac{{z}^{′}}{{P}_{B}} )$$

over the single helical pitch Pₕ. The amplitude A of the non-linear function and the Bragg period P_{B} are presumed to be constant values, e.g., A=18°, and P_{B}=0.2 μm. The value of the frequency n may be configured, such that the R-PVH element 200 may provide a primary (or main) reflection band and two additional secondary (or side) reflection bands. Through configuring the nonlinear azimuthal angle variation of the LC molecule 212, the R-PVH element 200 may provide a high reflection efficiency over a large AOI range in both the primary reflection band and the two secondary reflection bands.

In FIG. 4C, the vertical axis represents a wavelength of incidence (unit: m), and the horizontal axis represents diffraction angle (unit: degree). A color bar 430 (from blue (0) to red (1)) is shown to represent the normalized reflection efficiency. On the color bar 430, the blue color denotes a lower normalized reflection efficiency (between 0 and 0.3), and the red color denotes a higher normalized reflection efficiency (between 0.8 and 1). In the middle of the color bar is the green/yellow color representing medium normalized reflection efficiency between 0.3 and 0.8. As the color gradually changes from the blue to the red, the normalized reflection efficiency gradually increases from 0 to 1.

Referring to FIG. 4C, the R-PVH element 200 shown in FIGS. 2A and 2B may be configured to have a primary reflection band 431, and two secondary reflection bands 432 and 433 located at two sides of the primary reflection band 431. The primary reflection band 431, and two secondary reflection bands 432 and 433 may be separated from one another. The primary reflection band 431 may have a relatively broad bandwidth, and the secondary reflection band 432 or 433 may have a relatively narrow bandwidth. The R-PVH element 200 may provide a substantially high reflection efficiency (e.g., greater than 95%) for each of the primary reflection band 431, and two secondary reflection bands 432 and 433 over a large AOI range.

For discussion purposes, FIG. 4C shows that the primary reflection band 431 includes the green wavelength range, and the two secondary reflection bands 432 and 433 include the blue wavelength range and the red wavelength range, respectively. Thus, the R-PVH element 200 including the single R-PVH layer 215 may function as a broadband R-PVH device covering the visible wavelength range, with a substantially high reflection efficiency (e.g., greater than 95%) over a large AOI range. In some embodiments, although not shown, the primary reflection band 431 may be configured to include a suitable wavelength range other than the green wavelength range, and the two secondary reflection bands 432 and 433 may be configured to include suitable wavelength ranges other than the blue wavelength range and the red wavelength range.

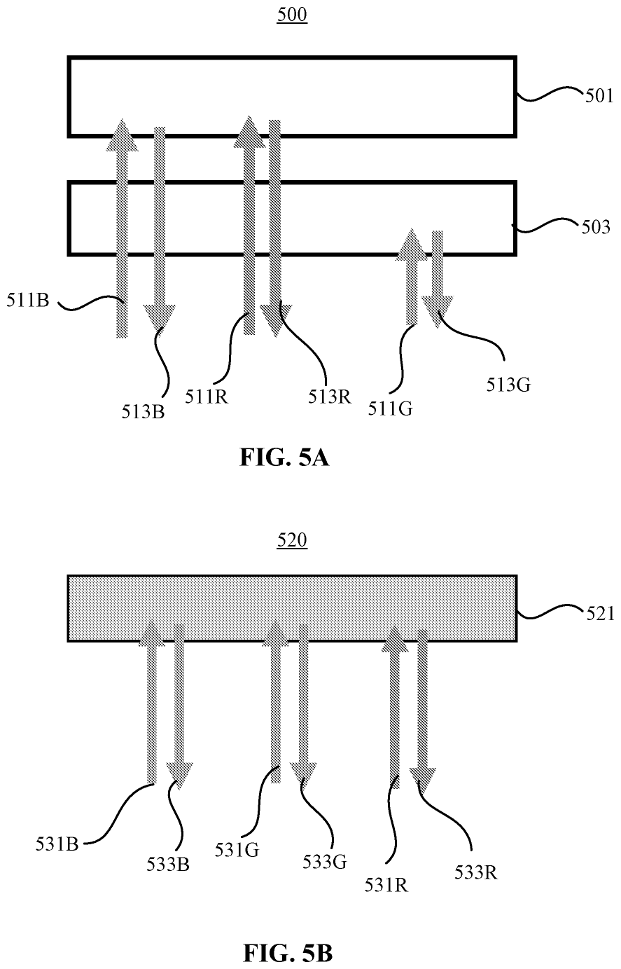

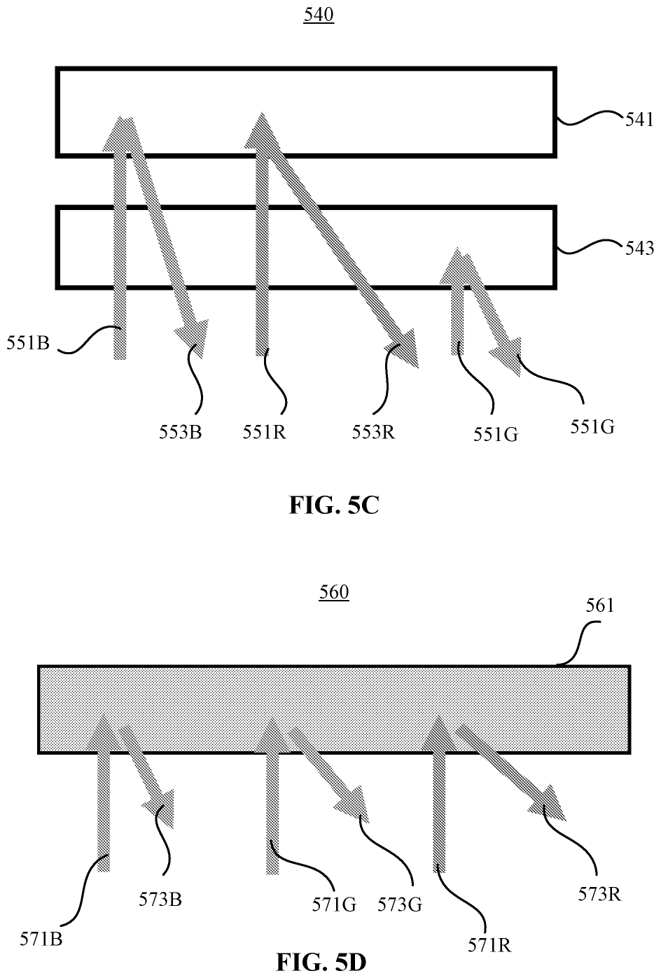

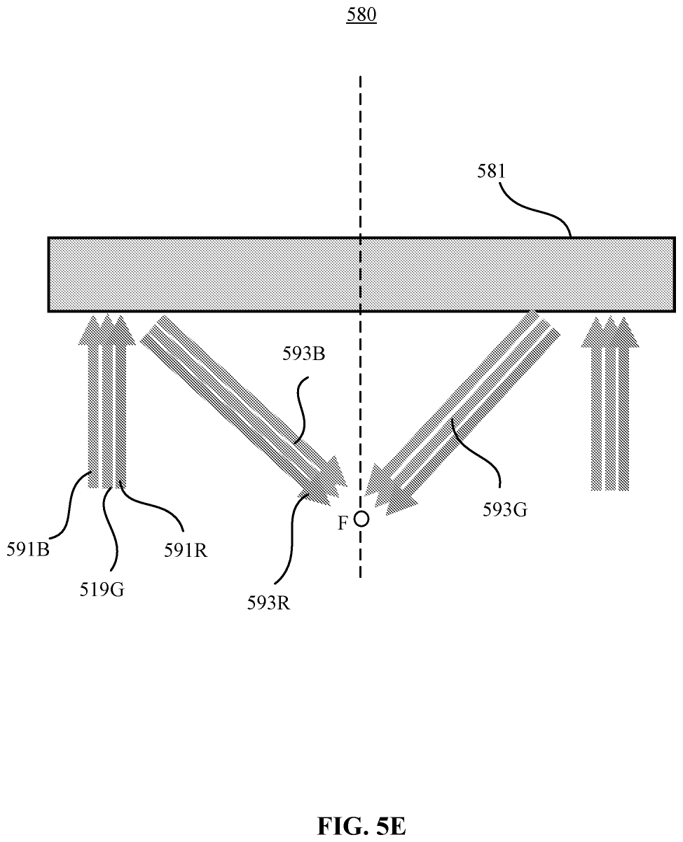

FIGS. 5A-5E illustrate diagrams of various broadband LCPH devices, according to various embodiments of the present disclosure. The broadband LCPH devices may include one or more disclosed LCPH elements configured with a nonlinearly varying azimuthal angle distribution, providing a substantially high reflection efficiency over a large AOI range. For discussion purposes, the broadband LCPH devices shown in FIGS. 5A-5E are configured for the visible wavelength range, which is used as an example in illustrating and explaining the principles of configuring broadband LCPH devices based on one or more disclosed LCPH elements. The principles may be applicable to configure broadband LCPH devices for other multiple wavelength ranges.

FIG. 5A illustrates an x-z sectional view of a broadband LCPH device 500, according to an embodiment of the present disclosure. As shown in FIG. 5A, the LCPH device 500 may be a broadband CLC device (also referred to as 500 for discussion purposes) including a stack of a first CLC layer 501 and a second CLC layer 503. In some embodiments, the first CLC layer 501 may be an embodiment of the disclosed CLC layers, such as the CLC layer 265 configured with the nonlinear azimuthal angle variation (e.g., n=0.75 or 0.5) shown in FIGS. 3A and 3B. For example, the first CLC layer 501 may be configured to have two operating wavelength ranges (or reflection bands) associated with the red wavelength range and the blue wavelength range, respectively. In some embodiments, the second CLC layer 503 may be a conventional CLC layer having an operating wavelength range (or a reflection band) associated with the green wavelength range.

An input light 511 of the CLC device 500 may be a polychromatic light including a red portion 511R, a green portion 511G, and a blue portion 5111B. For discussion purposes, the CLC device 500 may be a left-handed CLC device, and the input light 511 may be a left-handed circularly polarized polychromatic light, which is substantially normally incident onto the CLC device 500. The CLC device 500 may reflect the polychromatic input light 511 as a polychromatic output light 513 with a substantially high reflection efficiency (e.g., greater than 98%) over a large AOI range. For example, the first CLC layer 501 may reflect the red portion (or red input light) 511R and the blue portion (or blue input light) 511B as a red portion (or red output light) 513R and a blue portion (or blue output light) 513B of the polychromatic output light 513, respectively, while the second CLC layer 503 may reflect the green portion (or green input light) 511G as a green portion (or green output light) 513G of the polychromatic output light 513.

In some embodiments, although not shown, the second CLC layer 503 may also be an embodiment of the disclosed CLC layers having a nonlinear azimuthal angle variation. For example, the first CLC layer 501 may be configured to have a primary operating wavelength range (or reflection band) associated with the red wavelength range, and a secondary operating wavelength range associated with the blue wavelength range, in which the blue reflection band may have a narrower bandwidth than the red reflection band. The second CLC layer 503 may be configured to have a primary operating wavelength range associated with the green wavelength range, and a secondary operating wavelength range associated with the blue wavelength range, in which the blue reflection band may have a narrower bandwidth than the green reflection band. The blue reflection bands provided by the first CLC layer 501 and the second CLC layer 503 may be configured to be slightly overlapped with one another, such that the entire blue reflection band of the CLC device 500 (that is a combination of the two blue reflection bands provided by the first CLC layer 501 and the second CLC layer 503) may be further broadened. The nonlinear azimuthal angle variations in the first CLC layer 501 and the second CLC layer 503 may be different.

FIG. 5B illustrates an x-z sectional view of a broadband LCPH device 520, according to an embodiment of the present disclosure. As shown in FIG. 5B, the LCPH device 520 may be a broadband CLC device (also referred to as 520 for discussion purposes) including a single CLC layer 521. The CLC layer 521 may be an embodiment of the disclosed CLC layers, such as the CLC layer 265 configured with the nonlinear azimuthal angle variation shown in FIGS. 4A and 4B. For example, the CLC layer 521 may be configured to have three operating wavelength ranges (or reflection bands) associated with the red wavelength range, the green wavelength range, and the blue wavelength range, respectively.

An input light 531 of the CLC device 520 may be a polychromatic light including a red portion 531R, a green portion 531G, and a blue portion 531B. For discussion purposes, the CLC device 520 may be a left-handed CLC device, and the input light 531 may be a left-handed circularly polarized, polychromatic light, which is substantially normally incident onto the CLC device 520. The CLC device 520 may reflect the polychromatic input light 531 as a polychromatic output light 533 with a substantially high reflection efficiency (e.g., greater than 98%) over a large AOI range. For example, the CLC layer 521 may reflect the red portion (or red input light) 531R, the green portion (or green input light) 531G, and the blue portion (or blue input light) 531B as a red portion (or red output light) 533R, a green portion (or green output light) 533G, and a blue portion (or blue output light) 533B of the polychromatic output light 533, respectively.

FIG. 5C illustrates an x-z sectional view of a broadband LCPH device 540, according to an embodiment of the present disclosure. As shown in FIG. 5C, the LCPH device 540 may be a broadband R-PVH device (also referred to as 540 for discussion purposes) including a stack of a first R-PVH layer 541 and a second R-PVH layer 543. In some embodiments, the first R-PVH layer 541 may be an embodiment of the disclosed R-PVH layers, such as the R-PVH layer 215 configured with the nonlinear azimuthal angle variation shown in FIG. 3C. For example, the first R-PVH layer 541 may be configured to have two operating wavelength ranges associated with the red wavelength range and the blue wavelength range, respectively. In some embodiments, the second R-PVH layer 543 may be a conventional R-PVH layer having an operating wavelength range associated with the green wavelength range.

An input light 551 of the R-PVH device 540 may be a polychromatic light including a red portion 551R, a green portion 551G, and a blue portion 551B. For discussion purposes, the R-PVH device 540 may be a left-handed R-PVH device configured to substantially diffract a left-handed circularly polarized light, and substantially transmit a right-handed circularly polarized light with zero or negligible diffraction. The input light 551 may be a left-handed circularly polarized, polychromatic light, which is substantially normally incident onto the R-PVH device 540. The R-PVH device 540 may substantially backwardly diffract the polychromatic input light 551 as a polychromatic output light 553 with a substantially high diffraction efficiency (e.g., greater than 98%) over a large AOI range. For example, the first R-PVH layer 541 may diffract the red portion (or red input light) 551R and the blue portion (or blue input light) 551B as a red portion (or red output light) 553R and a blue portion (or blue output light) 553B of the polychromatic output light 553, respectively, while the second R-PVH layer 543 may diffract the green portion (or green input light) 551G as a green portion (or green output light) 553G of the polychromatic output light 553.

In some embodiments, although not shown, the second R-PVH layer 543 may also be an embodiment of the disclosed R-PVH layers having a nonlinear azimuthal angle variation. For example, the first R-PVH layer 541 may be configured to have a primary operating wavelength range associated with the red wavelength range, and a secondary operating wavelength range associated with the blue wavelength range, in which the blue reflection band may have a narrower bandwidth than the red reflection band. The second R-PVH layer 543 may be configured to have a primary operating wavelength range associated with the green wavelength range, and a secondary operating wavelength range associated with the blue wavelength range, in which the blue reflection band may have a narrower bandwidth than the green reflection band. The blue reflection bands provided by the first R-PVH layer 541 and the second R-PVH layer 543 may be configured to be slightly overlapped with one another, such that the entire blue reflection band of the R-PVH device 540 (that is a combination of the two blue reflection bands provided by the first R-PVH layer 541 and the second R-PVH layer 543) may be further broadened.

FIG. 5D illustrates an x-z sectional view of a broadband LCPH device 560, according to an embodiment of the present disclosure. As shown in FIG. 5D, the LCPH device 560 may be a broadband R-PVH device (also referred to as 560 for discussion purposes) including a single R-PVH layer 561. The R-PVH layer 561 may be an embodiment of the disclosed R-PVH layers, such as the R-PVH layer 215 configured with the nonlinear azimuthal angle variation shown in FIG. 4C. For example, the R-PVH layer 561 may be configured to have three operating wavelength ranges associated with the red wavelength range, the green wavelength range, and the blue wavelength range, respectively.

An input light 571 of the R-PVH device 560 may be a polychromatic light including a red portion 571R, a green portion 571G, and a blue portion 571B. For discussion purposes, the R-PVH device 560 may be a left-handed R-PVH device, and the input light 571 may be a left-handed circularly polarized, polychromatic light, which is substantially normally incident onto the R-PVH device 560. The R-PVH device 560 may diffract the polychromatic input light 571 as a polychromatic output light 573 with a substantially high diffraction efficiency (e.g., greater than 98%) over a large AOI range. For example, the R-PVH layer 561 may diffract the red portion (or red input light) 571R, the green portion (or green input light) 571G, and the blue portion (or blue input light) 571B as a red portion (or red output light) 573R, a green portion (or green output light) 573G, and a blue portion (or blue output light) 573B of the polychromatic output light 573, respectively.

For discussion purposes, the R-PVH device 540 in FIG. 5C and the R-PVH device 560 in FIG. 5D are shown as functioning as R-PVH gratings that backwardly diffract red, green, and blue incident lights in different diffraction angles (or reflect red, green, and blue incident lights in different reflection angles). For example, FIGS. 5C and 5D show that the diffraction angle of the red light, the green light, and the blue light gradually decrease. In some embodiments, although not shown, the nonlinear azimuthal angle variation of the LC molecules in the disclosed R-PVH device may be configured, such that disclosed R-PVH devices may be configured to backwardly diffract the red light, the green light, and the blue light in the same diffraction angle (or reflect red, green, and blue incident lights in the same reflection angle), thereby functioning as an apochromatic R-PVH device.

FIG. 5E illustrates an x-z sectional view of a broadband LCPH device 580, according to an embodiment of the present disclosure. As shown in FIG. 5E, the LCPH device 580 may be a broadband R-PVH device (also referred to as 580 for discussion purposes) including a single R-PVH layer 581. The R-PVH layer 581 may be an embodiment of the disclosed R-PVH layers, for example, the R-PVH layer 581 may be configured to have three operating wavelength ranges associated with the red wavelength range, the green wavelength range, and the blue wavelength range, respectively. In the embodiment shown in FIG. 5E, the R-PVH device 580 may be an apochromatic R-PVH lens configured to backwardly diffract lights of the three wavelength ranges by a common diffraction angle, and focus the lights of the three wavelength ranges to a common focal point F.

An input light 591 of the R-PVH device 580 may be a polychromatic light including a red portion 591R, a green portion 591G, and a blue portion 591B. For discussion purposes, the R-PVH device 580 may be a left-handed R-PVH device, and the input light 591 may be a left-handed circularly polarized, polychromatic light, which is substantially normally incident onto the R-PVH device 580. The R-PVH device 580 may substantially backwardly diffract the red portion (or red input light) 591R, the green portion (or green input light) 591G, and the blue portion (or blue input light) 591B of the input light 591 as a red light 593R, a green light 593G, and a blue light 593B having the common diffraction angle. The red light 593R, green light 593G, and blue light 593B may be focused to the common focal point F. In other words, the R-PVH device 580 may focus the polychromatic, input light 591 to the common focal point F. At an output side of the R-PVH device 580, the red light 593R, green light 593G, and blue light 593B may form a polychromatic output light 593 that is focused to the common focal point F.

The LCPH elements or devices disclosed herein have features of a high efficiency over a large AOI range, a high apochromatic efficiency, a small thickness, a light weight, compactness, no limitation of aperture, simple fabrication, etc. The LCPH elements or devices disclosed herein may be implemented in various systems for augmented reality (“AR”), virtual reality (“VR”), and/or mixed reality (“MR”) applications, e.g., near-eye displays (“NEDs”), head-up displays (“HUDs”), head-mounted displays (“HMDs”), smart phones, laptops, televisions, vehicles, etc. For example, in some embodiments, the disclosed LCPH elements or devices may be implemented in displays and optical modules to enable pupil steered AR, VR, and/or MR display systems, such as holographic near eye displays, retinal projection eyewear, and wedged waveguide displays. Pupil steered AR, VR, and/or MR display systems have features such as compactness, large field of views (“FOVs”), high system efficiencies, and small eye-boxes. The disclosed LCPH elements or devices may be implemented in the pupil steered AR, VR, and/or MR display systems to enlarge the eye-box spatially and/or temporally. In some embodiments, the disclosed LCPH elements or devices may be implemented in AR, VR, and/or MR sensing modules to detect objects in a wide angular range to enable other functions. In some embodiments, the disclosed LCPH elements or devices may be implemented in AR, VR, and/or MR sensing modules to extend the FOV (or detecting range) of the sensors in space constrained optical systems, increase detecting resolution or accuracy of the sensors, and/or reduce the signal processing time. The disclosed LCPH elements or devices may also be used in Light Detection and Ranging (“Lidar”) systems in autonomous vehicles.

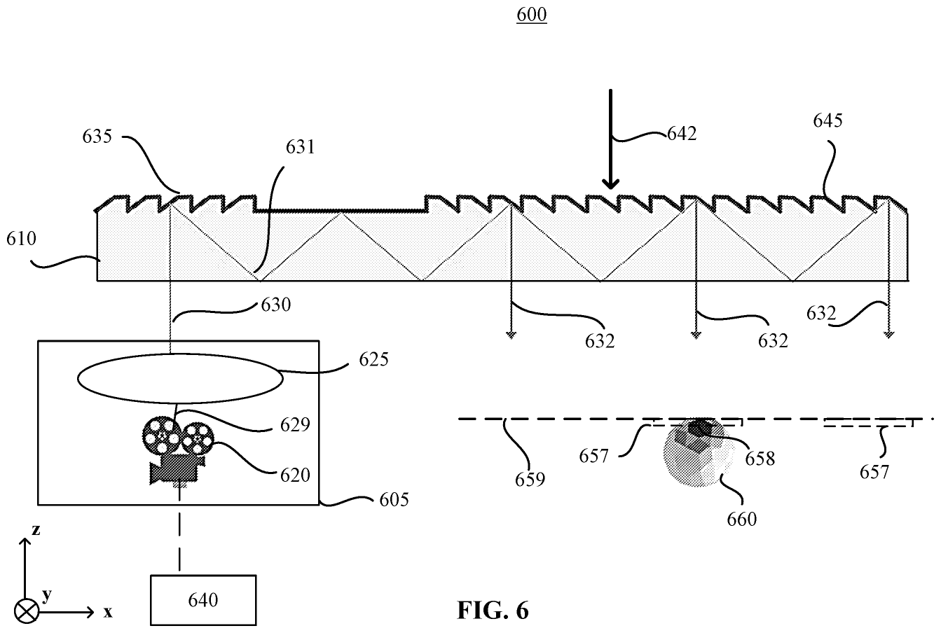

FIG. 6 schematically illustrates an x-z sectional view of a system 600, according to an embodiment of the present disclosure. The system 600 may also be referred to as a light guide display system or assembly. As shown in FIG. 6, the system 600 may include a light source assembly 605, a light guide 610 coupled with an in-coupling element (or input coupler) 635 and an out-coupling element (or output coupler) 645, and a controller 640. The light source assembly 605 may include a display element (e.g., a display panel) 620 and a collimating lens 625. The light guide 610 coupled with the in-coupling element 635 and the out-coupling element 645 may also be referred to as a light guide image combiner.

The display panel 620 may output an image light 629 representing a virtual image (having a predetermined image size associated with a linear size of the display panel 620) toward the collimating lens 625. The image light 629 may be a divergent image light including a bundle of rays. The image light 629 may be a polychromatic light or monochromatic light. For discussion purposes, FIG. 6 shows a single ray of the image light 629. The collimating lens 625 may transmit the image light 629 as an image light 630 having a predetermined input FOV (e.g., a) toward an input side of the light guide 610. The collimating lens 625 may transform or convert a linear distribution of the pixels in the virtual image formed by the image light 629 into an angular distribution of the pixels in the image light 630 having the predetermined input FOV. Each ray in the in the image light 630 may represent an FOV direction of the input FOV. For discussion purposes, FIG. 6 shows a single ray (e.g., central ray) of the image light 630 that is normally incident onto the in-coupling element 635, and the single ray of the image light 630 may represent a single FOV direction (e.g., 0° FOV direction) of the input FOV.

The in-coupling element 635 may couple the image light 630 into the light guide 610 as an in-coupled image light 631, which may propagate inside the light guide 610 toward the out-coupling element 645 via total internal reflection (“TIR”). The out-coupling element 645 may couple the in-coupled image light 631 out of the light guide 610 as a plurality of output image lights 632 at different locations along the longitudinal direction (e.g., x-axis direction) of the light guide 610, each of which may have an output FOV that may be substantially the same as the input FOV (e.g., as represented by an angle α). For discussion purposes, FIG. 6 shows three output image lights 632, and shows a single ray (e.g., central ray) of each output image light 632. At least one of the in-coupling element 635 or the out-coupling element 645 may include a grating that couples the image light into the light guide 610 or out of the light guide 610 via diffraction, and the grating may include an LCPH element or device disclosed herein, such as the LCPH device 540 shown in FIG. 5C or the LCPH device 560 shown in FIG. 5D.

Each output image light 632 may include the same image content as the virtual image displayed on the display panel 620. Thus, the light guide 610 coupled with the in-coupling element 635 and the out-coupling element 645 may replicate the image light 630 at the output side of the light guide 610, to expand an effective pupil of the system 600. For discussion purposes, FIG. 6 shows a one-dimensional pupil expansion along the x-axis direction in FIG. 6. In some embodiments, the system 600 may also provide a two-dimensional pupil expansion, e.g., along both the x-axis direction and the y-axis direction in FIG. 6. For example, in some embodiments, although not shown, the system 600 may also include a redirecting element (or folding element) coupled to the light guide 610, and configured to redirect the in-coupled image light 631 to the out-coupling element 645. The redirecting element may be configured to expand the input image light 630 in a first direction, e.g., the y-axis direction, and the out-coupling element 645 may be configured to expand the input image light 630 in a second, different direction, e.g., the x-axis direction. In some embodiments, the redirecting element may include a grating that redirects the in-coupled image light 631 to the out-coupling element 645 via diffraction, and the grating may include an LCPH element or device disclosed herein, such as the LCPH device 540 shown in FIG. 5C or the LCPH device 560 shown in FIG. 5D.

The plurality of image lights 632 may propagate through exit pupils 657 located in an eye-box region 659 of the system 600. The exit pupil 657 may correspond to a spatial zone where an eye pupil 658 of an eye 660 of a user may be positioned in the eye-box region 659 of the system 600 to perceive the virtual image. The size of a single exit pupil 657 may be larger than and comparable with the size of the eye pupil 658. The exit pupils 657 may be sufficiently spaced apart, such that when one of the exit pupils 657 substantially coincides with the position of the eye pupil 658, the remaining one or more exit pupils 657 may be located beyond the position of the eye pupil 658 (e.g., falling outside of the eye 660). The light guide 610 and the out-coupling element 645 may also transmit a light 642 from a real-world environment (referred to as a real-world light 642), combining the real-world light 642 with the output image light 632 and delivering the combined light to the eye 660. Thus, the eye 660 may observe the virtual scene optically combined with the real world scene.

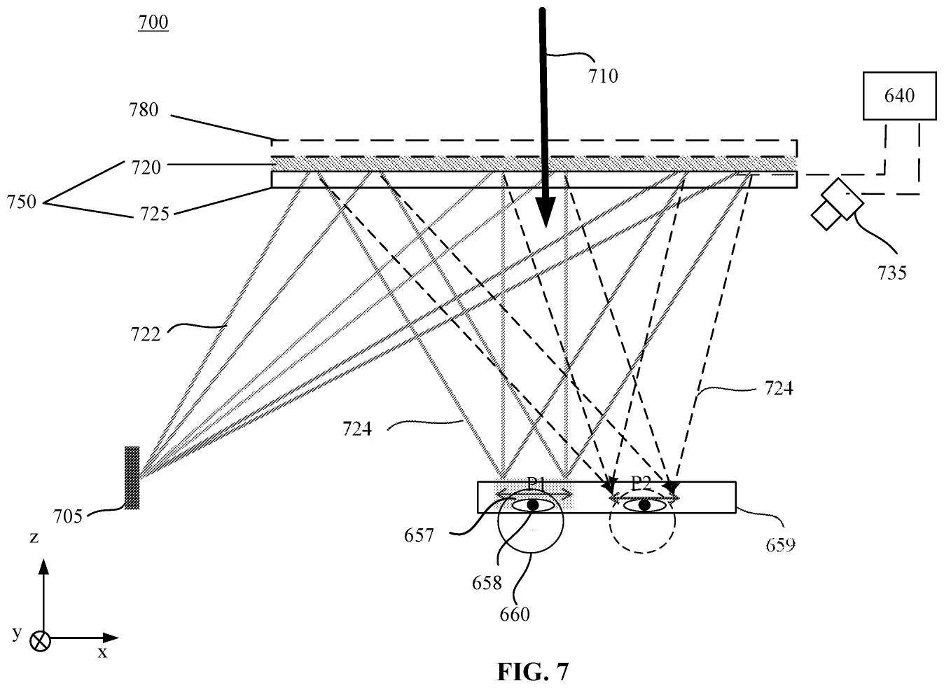

FIG. 7 schematically illustrates an x-z sectional view of a system 700, according to an embodiment of the present disclosure. As shown in FIG. 7, the system 700 may include a display element 705, an image combiner 750 including a reflective lens 720 and a beam steering device 725, an eye-tracking device 735, and the controller 640. The controller 640 may be electrically coupled with and control various devices in the system 700, including, but not limited to, the display element 705, the eye-tracking device 735, and the beam steering device 725. The beam steering device 725 may be disposed at a side of the reflective lens 752 facing a user. The display element 705 may be configured to generate an image light 722 representing a virtual image. In some embodiments, the display element 705 may include a projector (e.g., retinal projection display) configured to output the image light 722. In some embodiments, the display element 705 may be an off-axis display element configured to provide an off-axis projection with respective to the reflective lens 720, e.g., the image light 722 may be an off-axis light beam with respective to the reflective lens 720.

The image combiner 750 may be configured to reflect and focus the image light 722 to propagate through one or more exit pupils 657 within the eye-box region 659 of the system 700. The reflective lens 720 may include one or more disclosed LCPH elements or devices, such as the LCPH device 580 shown in FIG. 5E. The reflective lens 720 may function as an off-axis reflective lens configured to reflect and focus the off-axis image light 722 to one or more spots within the eye-box region 659 of the system 700. For example, the reflective lens 720 may reflect and focus the off-axis image light 722 as an image light 724 propagating toward the beam steering device 725. The beam steering device 725 may steer the image light 724 to one or more exits pupil 657 within the eye-box region 659.

The eye-tracking device 735 may be configured to provide eye-tracking information relating to the eye pupil 658 of the user of the system 700. Any suitable eye-tracking device 735 may be used. The eye-tracking device 735 may include, e.g., one or more light sources that illuminate one or both eyes of the user, and one or more cameras that capture images of one or both eyes. The eye-tracking device 735 may be configured to track a position, a movement, and/or a viewing direction of the eye pupil 658. In some embodiments, the eye-tracking device 735 may measure the eye position and/or eye movement up to six degrees of freedom for each eye (i.e., 3D positions, roll, pitch, and yaw). In some embodiments, the eye-tracking device 735 may measure a pupil size. The eye-tracking device 735 may provide a signal (or feedback) containing the position and/or movement of the eye pupil 658 to the controller 640.

For discussion purposes, FIG. 7 shows two operation states of the beam steering device 725. For example, at a first time instance, the eye tracking device 735 may detect that the eye pupil 658 of the user is located at a position P1 at the eye-box region 659. Based on the eye-tracking information, the controller 640 may control the beam steering device 725 to steer the image light 724 to propagate through an exit pupil corresponding to the position P1 within the eye-box region 659. At a second time instance, the eye tracking device 735 may detect that the eye pupil 658 of the user has moved to a new position P2 at the eye-box region 659 in the x-axis direction from the previous position P1. Based on new eye-tracking information relating to the new position P2, the controller 640 may control the beam steering device 725 to steer the image light 724 to propagate through an exit pupil corresponding to the position P2 within the eye-box region 659.

For discussion purposes, FIG. 7 shows that the beam steering device 725 provides a 1D pupil steering, e.g., steering the exit pupil 657 in the x-axis direction shown in FIG. 7. In some embodiments, although not shown, the beam steering device 725 may provide a 2D pupil steering, e.g., steering the exit pupil 657 in two different directions (e.g., the x-axis direction and the y-axis direction shown in FIG. 7). In some embodiments, although not shown, the reflective lens 720 may provide an adjustable optical power, and the beam steering device 725 and the reflective lens 720 together may provide a 3D pupil steering, e.g., steering the exit pupil 657 in three different directions (e.g., the x-axis direction, the y-axis direction, and the z-axis direction shown in FIG. 7).

When configured for AR or MR applications, the image combiner 750 may also combine the image light 722 received from the display element 705 and a light beam 710 from a real-world environment (referred to as a real-world light beam 710), and direct both light beams 710 and 722 toward the eye-box region 659. In some embodiments, the system 700 may include a compensator 780 coupled (e.g., stacked) with the image combiner 750. The image combiner 750 may be disposed between the compensator 780 and the eye-box region 659. The real-world light beam 710 may be incident onto the compensator 780 before being incident onto the image combiner 750. In some embodiments, the controller 640 may be configured to control the compensator 780 and the image combiner 750 to provide opposite steering effects and lensing effects to the real-world light beam 710. For example, the optical powers provided by the compensator 780 and the image combiner 750 may have opposite signs and a substantially same absolute value, the steering provided by the compensator 780 and the image combiner 750 may have opposite directions. Thus, the compensator 780 may compensate for the distortion of the real-world light beam 710 caused by the image combiner 750, such that images of real-world objects viewed through the system 700 may be substantially unaltered. In some embodiments, the compensator 780 may include one or more disclosed LCPH elements or devices, such as the LCPH device 580 shown in FIG. 5E. In some embodiments, when the system 700 is configured for VR applications, the compensator 780 may be omitted.

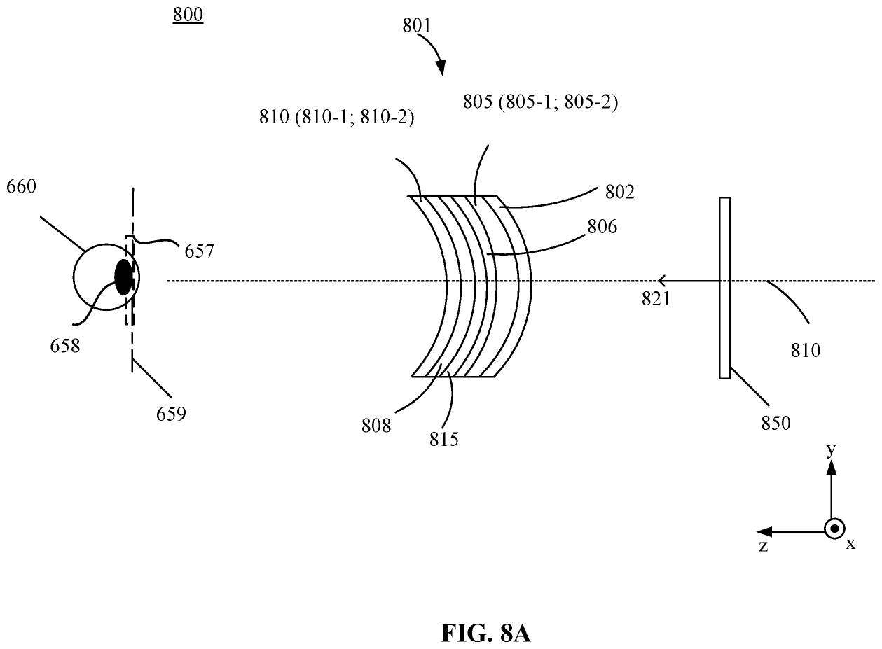

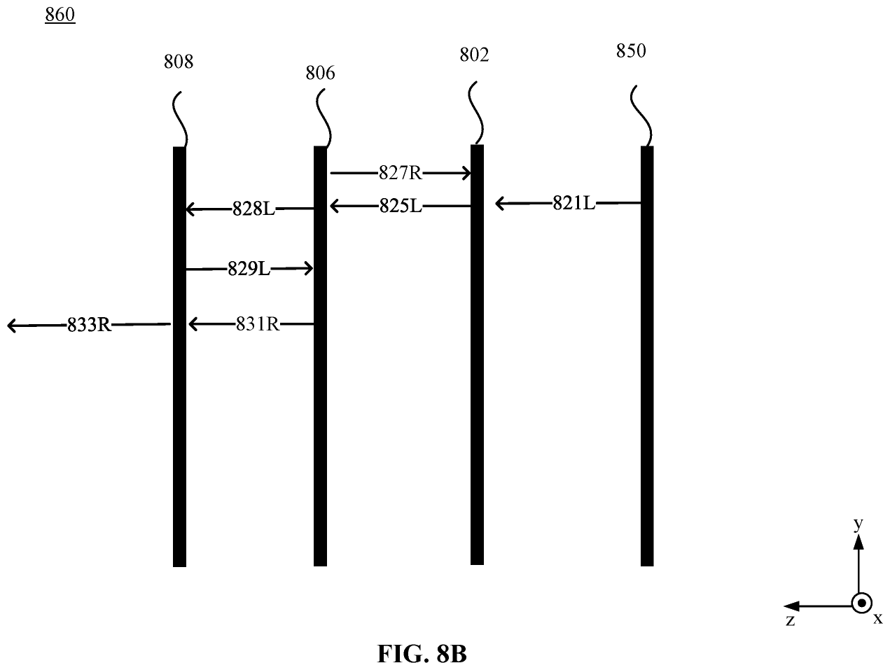

FIG. 8A schematically illustrates an z-x sectional view of a system 800, according to an embodiment of the present disclosure. The system 800 may include an light source assembly (e.g., a display element) 850 configured to output an image light 821 (e.g., a divergent image light) representing a virtual image. In some embodiments, the display element 850 may be a polychromatic display (e.g., a red-green-blue (“RGB”) display) that includes a broadband polychromatic light source (e.g., 300-nm-bandwidth light source covering the visible wavelength range). In some embodiments, the display element 850 may be a polychromatic display (e.g., an RGB display) including a stack of a plurality of monochromatic displays, which may include corresponding narrowband monochromatic light sources respectively. In some embodiments, the image light 821 emitted from the display element 850 may be a circularly polarized light.

The system 800 may also include a path-folding lens assembly (e.g., pancake lens assembly) 801 configured to fold the optical path of the image light 821, and transform the rays (forming the divergent image light 821) emitted from each light outputting unit of the display element 850 into a bundle of parallel rays that substantially covers one or more exit pupils 657 in the eye-box region 659 of the system 800. Due to the path folding, the lens assembly 801 may increase an FOV of the system 800 without increasing the physical distance between the display element 850 and the eye-box region 659, and without compromising the image quality.

In some embodiments, the pancake lens assembly 801 may include a first optical element (e.g., a first optical lens) 805 and a second optical element (e.g., a second optical lens) 810. In some embodiments, the pancake lens assembly 801 may be configured as a monolithic pancake lens assembly without any air gaps between optical elements included in the pancake lens assembly. In some embodiments, one or more surfaces of the first optical element 805 and the second optical element 810 may be shaped (e.g., curved) to compensate for field curvature. In some embodiments, one or more surfaces of the first optical element 805 and/or the second optical element 810 may be shaped to be spherically concave (e.g., a portion of a sphere), spherically convex, a rotationally symmetric asphere, a freeform shape, or some other shape that can mitigate field curvature. In some embodiments, the shape of one or more surfaces of the first optical element 805 and/or the second optical element 810 may be designed to additionally compensate for other forms of optical aberration. In some embodiments, the first optical element 805 and the second optical element 810 may be coupled together by an adhesive 815.

The first optical element 805 may include a first surface 805-1 facing the display element 850 and an opposing second surface 805-2 facing the eye 660. The pancake lens assembly 801 may include a circular polarizer 802 and a mirror 806 arranged in an optical series, each of which may be an individual layer, film, or coating disposed at (e.g., bonded to or formed at) the first optical element 805. The circular polarizer 802 or the mirror 806 may be disposed at (e.g., bonded to or formed at) the first surface 805-1 or the second surface 805-2 of the first optical element 805. For discussion purposes, FIG. 8A shows that the circular polarizer 802 is disposed at (e.g., bonded to or formed at) the first surface 805-1 facing the display element 850, and the mirror 806 is disposed at (e.g., bonded to or formed at) the second surface 805-2 facing the second optical element 810.

The circular polarizer 802 may be configured to substantially transmit the image light 821 emitted from the display element 850. In some embodiments, the mirror 806 may be a polarization non-selective partial reflector that is partially reflective to reflect a portion of a received light. In some embodiments, the mirror 806 may be configured to transmit about 5°% and reflect about 5°% of a received light, and may be referred to as a “50/50 mirror.” In some embodiments, the handedness of the reflected light may be reversed, and the handedness of the transmitted light may remain unchanged.

The second optical element 810 may have a first surface 810-1 facing the first optical element 805 and an opposing second surface 810-2 facing the eye 660. The pancake lens assembly 801 may also include a reflective polarizer 808, which may be an individual layer, film, or coating disposed at (e.g., bonded to or formed at) the second optical element 810. The reflective polarizer 808 may be disposed at (e.g., bonded to or formed at) the first surface 810-1 or the second surface 810-2 of the second optical element 810 and may receive a light output from the mirror 806. For discussion purposes, FIG. 8A shows that the reflective polarizer 808 is disposed at (e.g., bonded to or formed at) the first surface 810-1 of the second optical element 810. The reflective polarizer 808 may be configured to primarily reflect a circularly polarized light having a first handedness and primarily transmit a circularly polarized light having a second handedness that is orthogonal to the first handedness. The reflective polarizer 808 may include an LCPH element disclosed herein, such as the LCPH device 500 shown in FIG. 5A or the LCPH device 520 shown in FIG. 5B.

The pancake lens assembly 801 shown in FIG. 8A is merely for illustrative purposes. In some embodiments, one or more of the first surface 805-1 and the second surface 805-2 of the first optical element 805 and the first surface 810-1 and the second surface 810-2 of the second optical element 810 may be curved surface(s) or flat surface(s). In some embodiments, the pancake lens assembly 801 may further additional optical elements that are not shown in FIG. 8A, such as one or more linear polarizers, one or more waveplate, one or more circular polarizers, etc.

FIG. 8B illustrates a schematic cross-sectional view of an optical path 860 of a light propagating in the pancake lens assembly 801 shown in FIG. 8A, according to an embodiment of the present disclosure. In the light propagation path 860, the change of polarization of the light is shown. Thus, the first optical element 805 and the second optical element 810, which are presumed to be lenses that do not affect the polarization of the light, are omitted for the simplicity of illustration. In FIG. 8B, the letter “R” appended to a reference number (e.g., “827R”) denotes a right-handed circularly polarized light, and the letter “L” appended to a reference number (e.g., “825L”) denotes a left-handed circularly polarized light.

For discussion purposes, as shown in FIG. 8B, the image light 821 emitted from the display element 850 may be a left-handed circularly polarized light. The circular polarizer 802 may be configured to transmit a left-handed circularly polarized light, and block a right-handed circularly polarized light via absorption. The reflective polarizer 808 may be a left-handed reflective polarizer configured to reflect a left-handed circularly polarized light and transmit a right-handed circularly polarized light. For discussion purposes, the circular polarizer 802, the mirror 806, and the reflective polarizer 808 are illustrated as flat surfaces in FIG. 8B. In some embodiments, one or more of the circular polarizer 802, the mirror 806, and the reflective polarizer 808 may have a curved surface.

As shown in FIG. 8B, the display element 850 may generate the left-handed circularly polarized image light 821L covering a predetermined spectrum, such as a portion of the visible spectral range or substantially the entire visible spectral range. The left-handed circularly polarized image light 821 may be transmitted by the circular polarizer 802 as a left-handed circularly polarized image light 825. The mirror 806 may reflect a first portion of the left-handed circularly polarized image light 825 back to the circular polarizer 802 as a right-handed circularly polarized image light 827, and transmit a second portion of the left-handed circularly polarized image light 825 as a left-handed circularly polarized image light 828 propagating toward the reflective polarizer 808. The circular polarizer 802 may block the right-handed circularly polarized image light 827 from incident onto the display element 850. The reflective polarizer 808 may reflect the left-handed circularly polarized image light 828 back to the mirror 806 as a left-handed circularly polarized image light 829. The mirror 806 may reflect the left-handed circularly polarized image light 829 as a right-handed circularly polarized image light 831, which may be transmitted through the reflective polarizer 808 as a right-handed circularly polarized image light 833 toward the eye-box region 659.

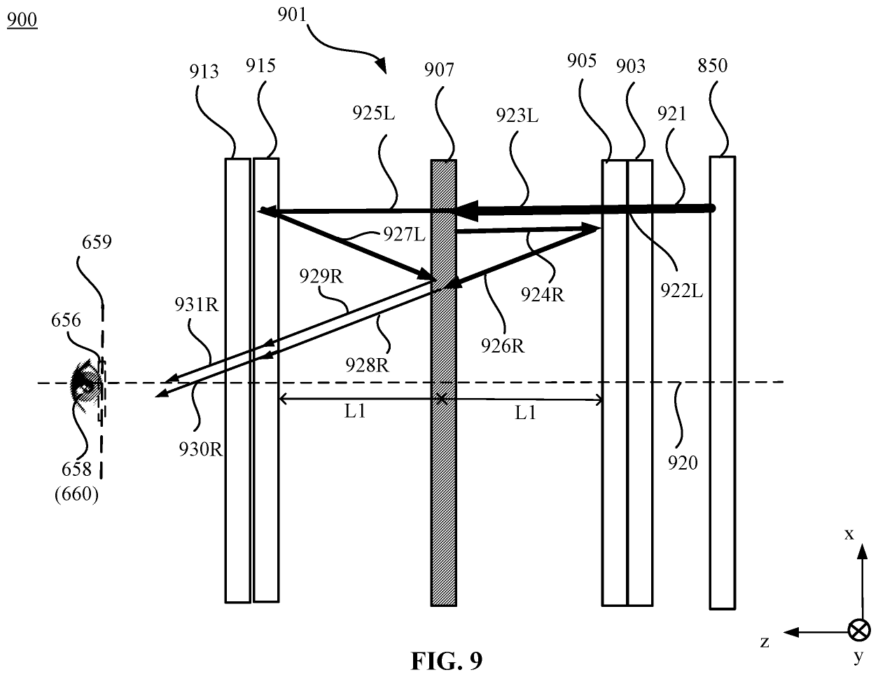

FIG. 9 schematically illustrates an x-z sectional view of a system 900, according to an embodiment of the present disclosure. The system 900 may include the display element 850 (which is an example of a light source) configured to output an image light 921 representing a virtual image, and a path-folding lens assembly 901 (also referred to as lens assembly 901) configured to fold the path of the image light 921 from the display element 850 to the eye-box region 659. The lens assembly 901 may be disposed between the display element 850 and the eye-box region 659. The lens assembly 901 may transform the rays (forming a divergent image light) emitted from each light outputting unit of the display element 850 into a bundle of parallel rays that substantially cover one or more exit pupils 657 in the eye-box region 659 of the system 900. For discussion purposes, FIG. 9 shows a single ray of the image light 921 emitted from a light outputting unit (e.g., a pixel) at the upper half of the display element 850.

The lens assembly 901 may include a first circular polarizer 903, a first polarization selective reflector 905 (e.g., a first LCPH element configured with a first optical power (i.e., functioning as a first LCPH lens)), a polarization non-selective partial reflector 907 (also referred to as a partial reflector 907), a second polarization selective reflector 915 (e.g., a second LCPH element configured with a second optical power (i.e., functioning as a second LCPH lens)), and a second circular polarizer 913 arranged in an optical series. For discussion purposes, the first polarization selective reflector 905 and the second polarization selective reflector 915 are referred to as a first LCPH element 905 and a second LCPH element 915, respectively. In the embodiment shown in FIG. 9, at least one of the first LCPH element 905 or the second LCPH element 915 may include a disclosed LCPH element or device, such as the LCPH device 580 shown in FIG. 5E.

The partial reflector 907 may be configured to partially transmit an input light while maintaining the polarization and propagation direction, and partially reflect the input light while changing the polarization, independent of the polarization of the input light. That is, regardless of the polarization of the input light, the partial reflector 907 may partially transmit the input light and partially reflect the input light. For discussion purposes, the partial reflector 907 is also referred to as a mirror. In some embodiments, the mirror 907 may be configured to transmit about 5°% of an input light and reflect about 5°% of the input light (referred to as a 50/50 mirror).

FIG. 9 illustrates an optical path or a propagation path of the image light 921 propagating from the display element 850 to the eye-box region 659 through the lens assembly 901. In below figures, the letter “R” appended to a reference number (e.g., “1124R”) denotes a right-handed circularly polarized (“RHCP”) light, and the letter “L” appended to a reference number (e.g., “1123L”) denotes a left-handed circularly polarized (“LHCP”) light.

In the embodiment shown in FIG. 9, the first LCPH element 905 and the second LCPH element 915 may have the same optical power and different polarization selectivities (e.g., may reflect lights of orthogonal polarizations). For example, the first LCPH element 905 may function as a right-handed LCPH lens that reflects and converges, via diffraction, a right-handed circularly polarized light, and transmits a left-handed circularly polarized light with negligible or zero diffraction. The second LCPH element 915 may function as a left-handed LCPH lens that reflects and converges, via diffraction, a left-handed circularly polarized light, and transmits a right-handed circularly polarized light with negligible or zero diffraction. A distance (e.g., L1) between the first LCPH element 905 and the mirror 907 may be equal to a distance (e.g., L1) between the second LCPH element 915 and the mirror 907. In some embodiments, the first LCPH element 905 and the second LCPH element 915 may have different optical powers, and the distance between the first LCPH element 905 and the mirror 907 may be different from the distance the second LCPH element 915 and the mirror 907. For discussion purposes, in the embodiment shown in FIG. 9, the image light 921 may be a left-handed circularly polarized light.

As shown in FIG. 9, the first circular polarizer 903 may transmit the image light 921 as an image light 922L. The first LCPH element 905 may substantially transmit the image light 922L as an image light 923L toward the mirror 907. The mirror 907 may transmit a first portion of the image light 923L as an image light 925L toward the second LCPH element 915, and reflect a second portion of the image light 923L back to the first LCPH element 905 as an image light 924R. The second LCPH element 915 may substantially reflect and converge, via diffraction, the image light 925L as an image light 927L toward the mirror 907. The mirror 907 may transmit a first portion of the image light 927L toward the first LCPH element 905 as a left-handed circularly polarized image light (not shown), and reflect a second portion of the image light 927L back to the second LCPH element 915 as an image light 929R. The second LCPH element 915 may substantially transmit the image light 929R while maintaining the polarization and propagation direction. The second circular polarizer 913 may transmit the image light 929R as an image light 931R toward the eye-box region 659.

When the image light 923L is normally incident onto the mirror 907, the image light 924R may propagate in a direction opposite to the propagation direction of the image light 923L. That is, the image light 924R and the image light 923L may substantially coincide with one another and have opposite propagation directions. To better illustrate the optical paths of the image light 924R and the image light 923L, FIG. 9 shows a small gap between the image light 924R and the image light 923L. The first LCPH element 905 may reflect and converge, via diffraction, the image light 924R as an image light 926R toward the mirror 907. The mirror 907 may transmit a first portion of the image light 926R toward the second LCPH element 915 as an image light 928R, and reflect a second portion of the image light 926R back to the first LCPH element 905 as a left-handed circularly polarized image light (not shown). The second LCPH element 915 may substantially transmit the image light 928R, while maintaining the propagation direction and the polarization. The second circular polarizer 913 may transmit the image light 928R as an image light 930R toward the eye-box region 659. In FIG. 9, as the first LCPH element 905 and the second LCPH element 915 have the same optical power, and the same axial distance (e.g., L1) to the mirror 907 along an optical axis 920 of the system 900, the image light 930R and the image light 931R may substantially coincide or overlap with one another, forming a single image with a high image quality within the eye-box region 659.

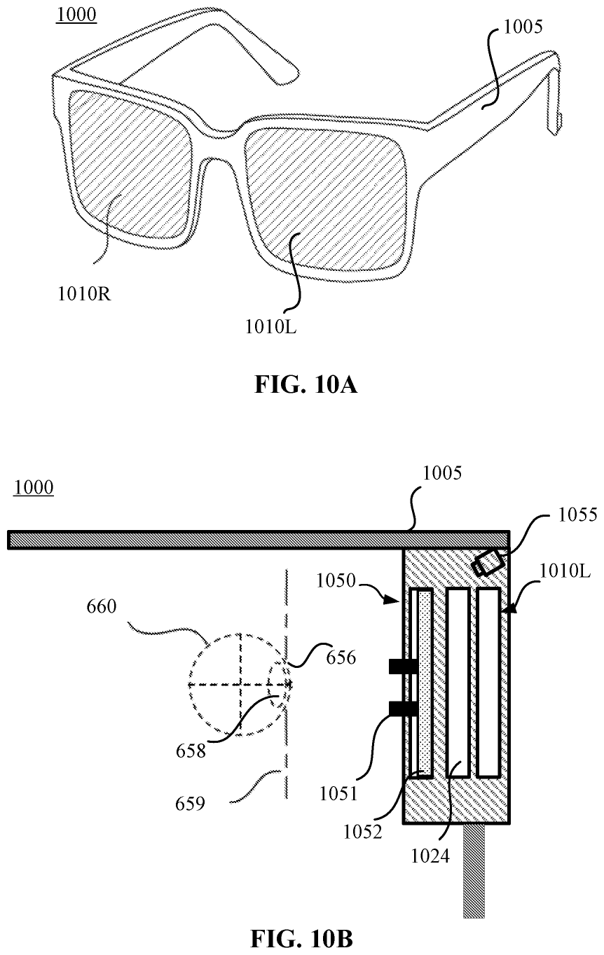

FIG. 10A illustrates a schematic diagram of an artificial reality device 1000 according to an embodiment of the present disclosure. In some embodiments, the artificial reality device 1000 may produce VR, AR, and/or MR content for a user, such as images, video, audio, or a combination thereof. In some embodiments, the artificial reality device 1000 may be smart glasses. In one embodiment, the artificial reality device 1000 may be a near-eye display (“NED”). In some embodiments, the artificial reality device 1000 may be in the form of eyeglasses, goggles, a helmet, a visor, or some other type of eyewear. In some embodiments, the artificial reality device 1000 may be configured to be worn on a head of a user (e.g., by having the form of spectacles or eyeglasses, as shown in FIG. 10A), or to be included as part of a helmet that is worn by the user. In some embodiments, the artificial reality device 1000 may be configured for placement in proximity to an eye or eyes of the user at a fixed location in front of the eye(s), without being mounted to the head of the user. In some embodiments, the artificial reality device 1000 may be in a form of eyeglasses which provide vision correction to a user's eyesight. In some embodiments, the artificial reality device 1000 may be in a form of sunglasses which protect the eyes of the user from the bright sunlight. In some embodiments, the artificial reality device 1000 may be in a form of safety glasses which protect the eyes of the user. In some embodiments, the artificial reality device 1000 may be in a form of a night vision device or infrared goggles to enhance a user's vision at night.

For discussion purposes, FIG. 10A shows that the artificial reality device 1000 includes a frame 1005 configured to mount to a user's head, and left-eye and right-eye display systems 1010L and 1010R mounted to the frame 1005. FIG. 10B is a cross-sectional view of half of the artificial reality device 1000 shown in FIG. 10A according to an embodiment of the present disclosure. For discussion purposes, FIG. 10B shows the cross-sectional view associated with the left-eye display system 1010L. The frame 1005 is merely an example structure to which various components of the artificial reality device 1000 may be mounted. Other suitable type of fixtures may be used in place of or in combination with the frame 1005.

In some embodiments, the left-eye and right-eye display systems 1010L and 1010R each may include suitable image display components configured to generate an image light representing a virtual image. In some embodiments, the left-eye and right-eye display systems 1010L and 1010R each may include suitable optical components configured to direct the image light toward the eye-box region 659. For example, in some embodiments, the left-eye and right-eye display systems 1010L and 1010R each may include a light guide display system, e.g., the system 600 shown in FIG. 6. In some embodiments, the left-eye and right-eye display systems 1010L and 1010R each may include the system 700 shown in FIG. 7, the display element 850 shown in FIG. 8A or FIG. 9.

In some embodiments, the artificial reality device 1000 may also include a viewing optics system 1024 disposed between the left-eye display system 1010L or right-eye display system 1010R and the eye-box region 659. The viewing optics system 1024 may be configured to guide an image light (representing a computer-generated virtual image) output from the left-eye display system 1010L or right-eye display system 1010R to propagate through one or more exit pupils 657 within the eye-box region 659. For example, the viewing optics system 1024 may include the path-folding lens assembly 801 shown in FIG. 8A, or the path-folding lens assembly 901 shown in FIG. 9, each of which may include an LCPH configured with a nonlinear azimuthal angle variation described above. In some embodiments, the viewing optics system 1024 may also be configured to perform a suitable optical adjustment of an image light output from the left-eye display system 1010L or right-eye display system 1010R, e.g., correct aberrations in the image light, adjust a position of the focal point of the image light in the eye-box region 659, etc.

In some embodiments, as shown in FIG. 10B, the artificial reality device 1000 may also include an object tracking system 1050 (e.g., eye tracking system and/or face tracking system). The object tracking system 1050 may include an IR light source 1051 configured to illuminate the eye 660 and/or the face, a light deflecting element 1052 configured to deflect the IR light reflected by the eye 660, and an optical sensor 1055 configured to receive the IR light deflected by the deflecting element 1052 and generate a tracking signal. A controller (e.g., one similar to controller 640 shown in FIG. 6) may be included in the artificial reality device 1000.

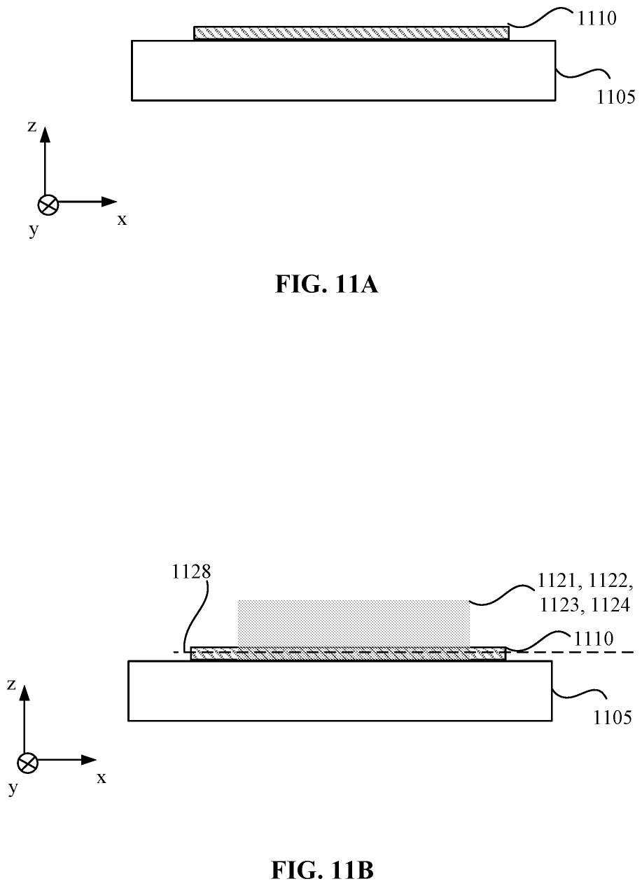

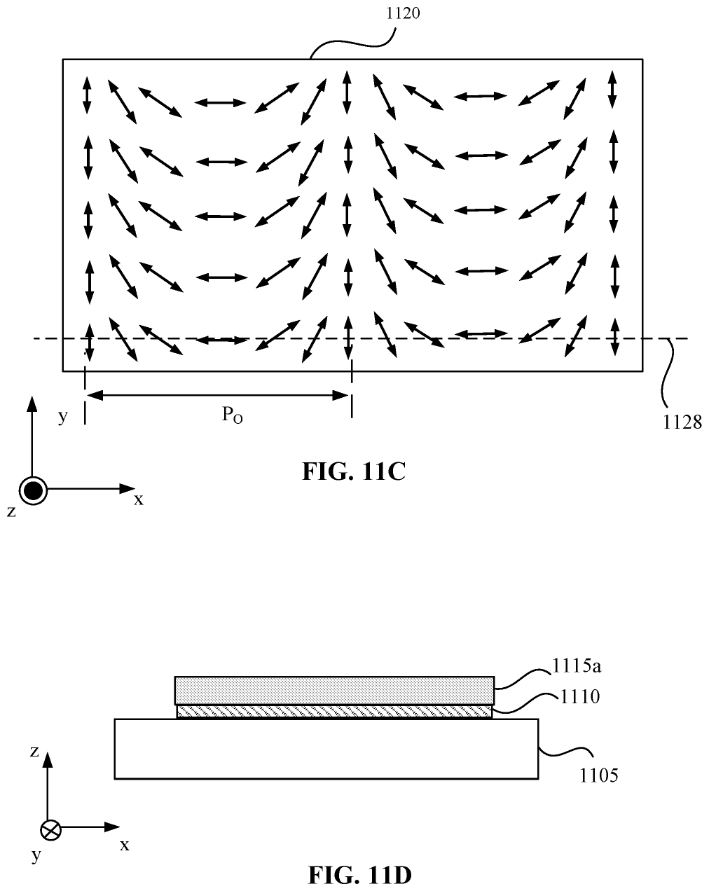

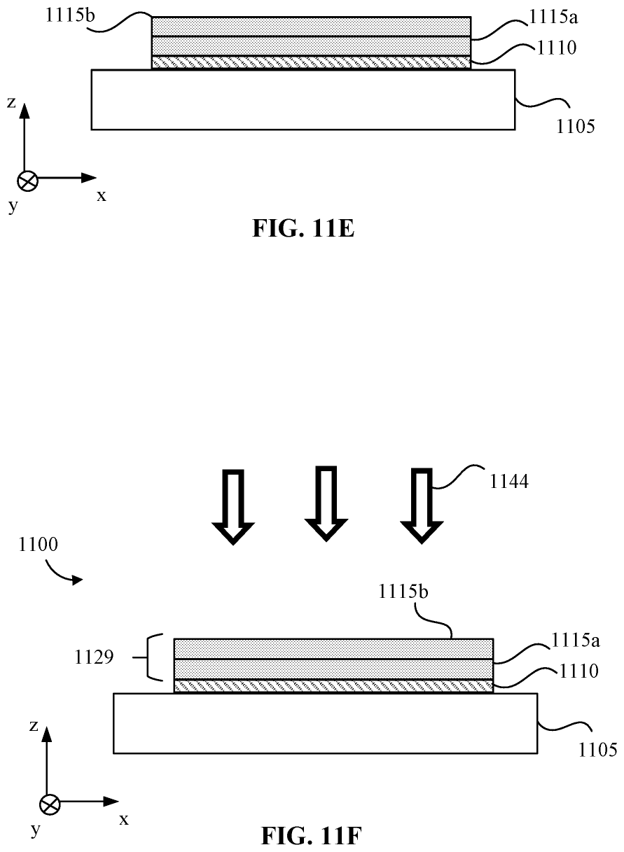

The present disclosure also provides processes for fabricating an LCPH element or device with a nonlinear azimuthal angle variation. FIGS. 11A-11F schematically illustrate processes for fabricating an LCPH element with a nonlinear azimuthal angle variation, according to an embodiment of the present disclosure. The fabrication processes shown in FIGS. 11A-11F may include holographic recording of an alignment pattern in a photo-alignment film, and aligning molecules of an anisotropic material (e.g., an LC material) by the photo-alignment film. The holographic recording of an alignment pattern in a photo-alignment film may also be referred to as surface recording. This alignment process may be referred to as a surface-mediated photo-alignment. For discussion purposes, the substrate and different layers, films, or structures formed thereon are shown as having flat surfaces. In some embodiments, the substrate and different layers or films or structures may have curved surfaces.

As shown in FIG. 11A, a recording medium layer 1110 may be formed on a surface (e.g., atop surface) of a substrate 1105 by dispensing, e.g., coating, printing, or depositing, a polarization sensitive material on the surface of the substrate 1105. The recording medium layer 1110 may include a polarization sensitive material, which is an optically recordable and polarization sensitive material (e.g., a photo-alignment material) configured to have a photo-induced optical anisotropy when exposed to a polarized light irradiation. Molecules (or fragments) and/or photo-products of the polarization sensitive material may be configured to generate an orientational ordering under a polarized light irradiation. In some embodiments, the polarization sensitive material may be dissolved in a solvent to form a solution. The solution may be dispensed on the substrate 1105 using any suitable solution coating process, e.g., spin coating, slot coating, blade coating, spray coating, or jet (ink-jet) coating or printing. The solvent may be removed from the coated solution using a suitable process, e.g., drying, or heating, leaving the polarization sensitive material on the substrate 1105 to form the recording medium layer 1110.

After the recording medium layer 1110 is formed on the substrate 1105, as shown in FIG. 11B, the recording medium layer 1110 may be exposed to a polarization interference pattern (e.g., 1120 shown in FIG. 11C) generated based on a plurality of recording beams 1121-1124, e.g. more than two recording beams. The recording beams 1121-1124 may be coherent circularly polarized beams, including at least one left-handed circularly polarized recording beam and at least one right-handed circularly polarized recording beam. For discussion purposes, FIG. 11B shows that four recording beams 1121-1124, e.g., two right-handed circularly polarized beams 1121 and 1122 and two left-handed circularly polarized beams 1123 and 1124, are used to generate the polarization interference pattern. In some embodiments, although not shown, three recording beams, or five recording beams, etc. may be used to generate the polarization interference pattern.

The recording beams 1121-1124 may have a wavelength within an absorption band of the recording medium layer 1110, e.g., ultraviolet (“UV”), violet, blue, or green beams. In some embodiments, the recording beams 1121-1124 may be laser beams, e.g., UV, violet, blue, or green laser beams. In some embodiments, the superposition of the recording beams 1121-1124 may result in a superimposed wave that has a spatially uniform intensity and a spatially varying linear polarization direction. For example, the linear polarization direction of the superimposed wave may spatially vary within a spatial region in which the recording beams 1121-1124 interfere with one another. In other words, the superimposed wave may have a linear polarization with a polarization direction that is spatially varying within the spatial region in which the recording beams 1121-1124 interfere with one another.

The superposition of the recording beams 1121-1124 may result in the polarization interference pattern 1120 shown in FIG. 2C at the recording medium layer 1110. The polarization interference pattern 1120 may also be referred to as a pattern of the spatially varying orientation (or polarization direction) of the linear polarization of the superimposed wave, or a pattern of the varying linear polarization of the superimposed wave. As shown in FIG. 11C, the orientation (or polarization direction) of the linear polarization may periodically or non-periodically vary along at least one in-plane direction 1128 within a surface of the recording medium layer 1110, with a pitch P_{O}. In some embodiments, a pitch P_{O} of the polarization interference pattern 1120 may be referred to as a distance along the in-plane direction 1128, over which the orientation (or polarization direction) of the linear polarization rotates by 180°. For discussion purposes, FIG. 11C shows that in the polarization interference pattern 1120, the orientation (or polarization direction) of the linear polarization periodically varies along the in-plane direction 1128 with the constant pitch P_{O}.

In some embodiments, the angles between the recording beams 1121-1124 may be configured, such that over the single pitch P_{O} of the polarization interference pattern 1120, the orientation (or polarization direction) of the linear polarization may be configured to rotate along the in-plane direction 1128 in a predetermined nonlinear manner. For example, over the single pitch P_{O} of the polarization interference pattern 1120, an angle of the orientation (or polarization direction) of the linear polarization with respect to the in-plane direction 1128 may be configured to vary along the in-plane direction 1128 in a predetermined nonlinear manner (or according to a predetermined nonlinear function). For discussion purposes, the polarization interference pattern 1120 may be referred to as a nonlinear polarization interference pattern 1120.

In some embodiments, the nonlinear polarization interference pattern 1120 may be resulted from a superposition of a first linear polarization interference pattern generated based on the right-handed circularly polarized recording beam 1121 and the left-handed circularly polarized recording beam 1123, and a second linear polarization interference pattern generated based on the right-handed circularly polarized recording beam 1122 and the left-handed circularly polarized recording beam 1124. For example, referring to FIG. 11B, the right-handed circularly polarized recording beam 1121 and the left-handed circularly polarized recording beam 1123 may interfere with one another to generate the first linear polarization interference pattern with a first pitch P₁ in the in-plane direction 1128. Over a single first pitch P₁ of the first linear polarization interference pattern, an angle of the orientation (or polarization direction) of the linear polarization with respect to the in-plane direction 1128 may be configured to vary along the in-plane direction 1128 in a first predetermined linear manner (or according to a first predetermined linear function). In addition, the right-handed circularly polarized recording beam 1122 and the left-handed circularly polarized recording beam 1124 may interfere with one another to generate the second linear polarization interference pattern with a second pitch P₂ in the in-plane direction 1128. Over a single second pitch P₂ of the second linear polarization interference pattern, an angle of the orientation (or polarization direction) of the linear polarization with respect to the in-plane direction 1128 may be configured to vary along the in-plane direction 1128 in a second predetermined linear manner (or according to a second predetermined linear function).

In some embodiments, a first angle formed between the right-handed circularly polarized recording beam 1121 and the left-handed circularly polarized recording beam 1123 may be configured to be different from a second angle formed between the right-handed circularly polarized recording beam 1122 and the left-handed circularly polarized recording beam 1124. Thus, the first pitch P₁ of the first linear polarization interference pattern may be configured to be different from the second pitch P₂ of the second linear polarization interference pattern, and the first predetermined linear manner may be configured to be different from the first predetermined linear manner. A superposition of the first linear polarization interference pattern and the second linear polarization interference pattern may generate the nonlinear polarization interference pattern 1120 shown in FIG. 11C.

Referring to FIGS. 11B and 11C, the recording medium layer 1110 may be optically patterned when exposed to the polarization interference pattern 1120 generated based on the recording beams 1121-1124 during the polarization interference exposure process. An orientation pattern of an optic axis of the recording medium layer 1110 may be defined by the polarization interference pattern 1120. In some embodiments, the recording medium layer 1110 may include elongated anisotropic photo-sensitive units (e.g., small molecules or fragments of polymeric molecules). After being subjected to a sufficient exposure of the polarization interference pattern 1120, local alignment directions of the anisotropic photo-sensitive units may be induced in the recording medium layer 1110 by the polarization interference pattern 1120, resulting in an alignment pattern (or in-plane modulation) of an optic axis of the recording medium layer 1110 due to a photo-alignment of the anisotropic photo-sensitive units. After the recording medium layer 1110 is optically patterned under the polarization interference pattern 1120, the recording medium layer 1110 may be referred to as a patterned recording medium layer with an alignment pattern.

As shown in FIG. 11D, after the patterned recording medium layer 1110 is formed, a first optically anisotropic film 1115a may be formed on the patterned recording medium layer 1110 by dispensing a birefringent medium onto the patterned recording medium layer 1110. For example, a birefringent medium may be dissolved in a solvent to form a solution. A suitable amount of the solution may be dispensed (e.g., coated, printed, or sprayed, etc.) on the patterned recording medium layer 1110 to form the first optically anisotropic film 1115a. In some embodiments, the solution containing the birefringent medium may be dispensed on the patterned recording medium layer 1110 using a suitable process, e.g., spin coating, slot coating, blade coating, spray coating, 3D printing, or jet (ink-jet) coating or printing, etc.

The birefringent medium may include a host birefringent material having an intrinsic birefringence, such as non-polymerizable LCs or polymerizable LCs (e.g., reactive mesogens (“RMs”)), and a chiral dopant. The chiral dopant may twist the LC molecules in the host birefringent material to form helical twist structures (also referred to as helical structures). In some embodiments, the birefringent medium may also include or be mixed with other ingredients, such as solvents, initiators (e.g., photo-initiators or thermal initiators), or surfactants, etc. The chirality of the birefringent medium may be introduced by the chiral dopant doped into the host birefringent material.

The patterned recording medium layer 1110 may be configured to provide a surface alignment to LC molecules in the first optically anisotropic film 1115a, at least partially aligning the LC molecules located in close proximity to the patterned recording medium layer 1110 in a predetermined non-uniform in-plane orientation pattern. For example, the LC molecules located in close proximity to the patterned recording medium layer 1110 may be at least partially aligned along the local alignment directions of the anisotropic photo-sensitive units in the patterned recording medium layer 1110 to form the predetermined non-uniform in-plane orientation pattern. Thus, the alignment pattern recorded in the patterned recording medium layer 1110 (or the in-plane orientation pattern of the optic axis of the recording medium layer 1110) may be transferred to the LC molecules located in close proximity to the patterned recording medium layer 1110. Accordingly, the LC molecules located in close proximity to the patterned recording medium layer 1110 may exhibit a nonlinear azimuthal angle variation along the in-plane direction 1128. The patterned recording medium layer 1110 may function as a photo-alignment material (“PAM”) layer for the LC molecules located in close proximity to the patterned recording medium layer 1110. Such an alignment procedure may be referred to as a surface-mediated photo-alignment.

As shown in FIG. 11E, after the first optically anisotropic film 1115a is formed on the patterned recording medium layer 1110, a second optically anisotropic film 1115b may be formed on the first optically anisotropic film 1115a. The first optically anisotropic film 1115a and the second optically anisotropic film 1115b may be fabricated based on a similar birefringent medium, which includes a host birefringent material and a chiral dopant. Referring to FIGS. 11D and 11E, the chiral dopant included in the optically anisotropic film 1115a or 1115b may have a helical twisting power (“HTP”) (unit: μm⁻¹), which is the ability of the chiral dopant to twist a host birefringent material. The HTP of the chiral dopant may exhibit a handedness, e.g., right-handedness or left-handedness. The helical pitch Pₕ of helical twist structures formed in the optically anisotropic film 1115a or 1115b may be determined by, in part, the HTP of the chiral dopant and the weight concentration (or molar fraction) of the chiral dopant in the host birefringent material. In some embodiments, the helical pitch Pₕ of the helical twist structures formed in the optically anisotropic film 1115a or 1115b may be inversely proportional to the HTP of the chiral dopant, and inversely proportional to the weight concentration (or molar fraction) of the chiral dopant in the host material. When the weight concentration of the chiral dopant is constant, a greater HTP of the chiral dopant may lead to a short helical pitch Pₕ of the helical twist structures. When the HTP of the chiral dopant is constant, a greater weight concentration (or molar fraction) of the chiral dopant in the host birefringent material may lead to a short helical pitch Pₕ of the helical twist structures.

In some embodiments, the chiral dopants included in the first optically anisotropic film 1115a and the second optically anisotropic film 1115b may be configured to have at least one difference in the HTP or the weight concentration, such that the helical twist structures formed in the first optically anisotropic film 1115a and the second optically anisotropic film 1115b may have different helical pitches Pₕ. In some embodiments, when the first optically anisotropic film 1115a and the second optically anisotropic film 1115b are fabricated to have the same predetermined thickness, due to the difference in the helical pitches Pₕ, the first optically anisotropic film 1115a and the second optically anisotropic film 1115b may exhibit different amounts of azimuthal angle variation of LC molecules over the same predetermined thickness.

For example, referring to FIG. 2E and FIG. 11E, the first optically anisotropic film 1115a and the second optically anisotropic film 1115b may be fabricated to have the same predetermined thickness of 0.05 m. From a lower surface of the first optically anisotropic film 1115a to an interface between the first optically anisotropic film 1115a and the second optically anisotropic film 1115b, the azimuthal angle of the LC molecules in the first optically anisotropic film 1115a may vary from 0° to 63° along the helical axis. From the interface between the first optically anisotropic film 1115a and the second optically anisotropic film 1115b to an upper surface of the second optically anisotropic film 1115b, the azimuthal angle of the LC molecules in the first optically anisotropic film 1115a may vary from 630 to 900 along the helical axis.

For discussion purposes, FIG. 11E merely illustrates two optically anisotropic films 1115a and 1115b, and additional optically anisotropic films may be successively formed on the second optically anisotropic film 1115b. For example, the azimuthal angle of the LC molecules in a third optically anisotropic film may be configured to vary from 900 to 1170 along the helical axis, and the azimuthal angle of the LC molecules in a fourth optically anisotropic film may be configured to vary from 1170 to 1800 along the helical axis, and so on. The multiple optically anisotropic film may form an optically anisotropic layer, within a volume of which a nonlinear azimuthal angle variation of the LC molecules may be established.

In some embodiments, as shown in FIG. 11F, the first optically anisotropic film 1115a and the second optically anisotropic film 1115b may be exposed to a polymerization irradiation 1144 to form a polymerized optically anisotropic layer 1129, thereby stabilizing the nonlinear azimuthal angle variation. In some embodiments, the exposure of the first optically anisotropic film 1115a and the second optically anisotropic film 1115b to the polymerization irradiation 1144 may be carried out in air, in an inert atmosphere formed by, e.g., nitrogen, argon, carbon-dioxide, or in vacuum. The polymerization irradiation 1144 may have a wavelength range within the absorption band of the photo-initiator, activating the photo-initiator to generate the polymerization initiating species. In some embodiments, the polymerization irradiation 1144 may be an ultra-violet (“UV”) irradiation. For example, as shown in FIG. 11F, the first optically anisotropic film 1115a and the second optically anisotropic film 1115b may be exposed to a UV light beam (also referred to as 1144 for discussion purposes). Under a sufficient exposure to the UV light beam 1144, the birefringent material (e.g., RM monomers) in the first optically anisotropic film 1115a and the second optically anisotropic film 1115b may be polymerized or crosslinked to stabilize the orientations of the LC molecules, thereby stabilizing the nonlinear azimuthal angle variation. In some embodiments, although not shown, the first optically anisotropic film 1115a may be exposed to the polymerization irradiation 1144 to form a first polymerized optically anisotropic film first. Then the second optically anisotropic film 1115b may be formed on the first polymerized optically anisotropic film, and exposed to the polymerization irradiation 1144 to form a second polymerized optically anisotropic film.

FIG. 11F also illustrates an x-z view of an LCPH element 1100 including the polymerized optically anisotropic layer 1129. The LCPH element 1100 may be an R-PVH element, and the polymerized optically anisotropic layer 1129 may be an R-PVH layer, e.g., similar to the R-PVH layer 200 shown in FIG. 2A. In some embodiments, the substrate 1105 and/or the alignment structure 1110 may be used to fabricate, store, or transport the fabricated LCPH element 1100. In some embodiments, the substrate 1105 and/or the alignment structure 1110 may be detachable or removable from the fabricated LCPH element 1100 after the LCPH element 1100 is fabricated or transported to another place or device. That is, the substrate 1105 and/or the alignment structure 1110 may be used in fabrication, transportation, and/or storage to support the LCPH element 1100 provided on the substrate 1105 and/or the alignment structure 1110, and may be separated or removed from the LCPH element 1100 when the fabrication of the LCPH element 1100 is completed, or when the LCPH element 1100 is to be implemented in an optical device. In some embodiments, the substrate 1105 and/or the alignment structure 1110 may not be separated from the LCPH element 1100.

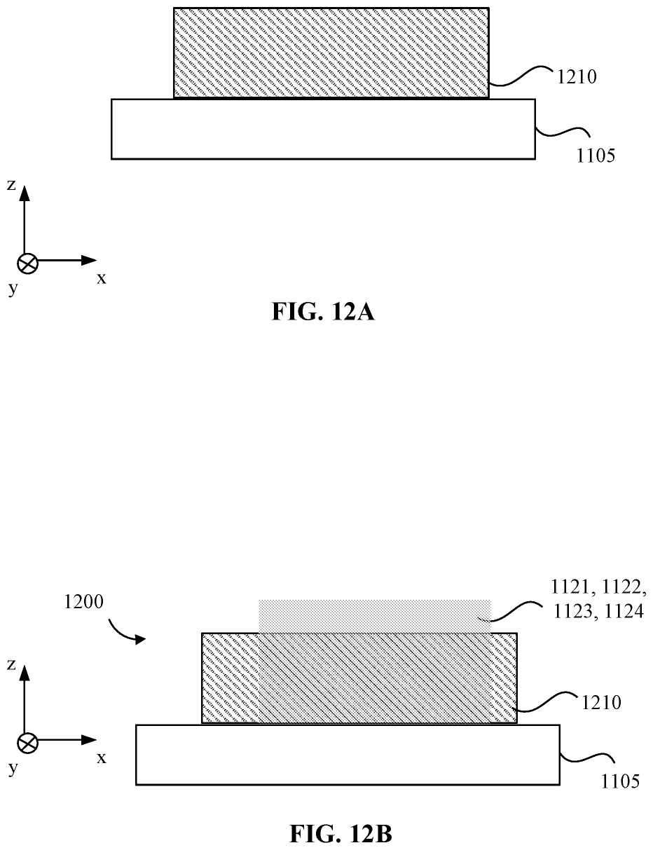

FIGS. 12A and 12B schematically illustrate processes for fabricating an LCPH element with a nonlinear azimuthal angle variation, according to an embodiment of the present disclosure. The fabrication processes shown in FIGS. 12A and 12B may include holographic recording and bulk-mediated photo-alignment (also referred to as volume recording). The fabrication processes shown in FIGS. 12A and 12B may include steps similar to those shown in FIGS. 11A-11F. The LCPH element fabricated based on the processes shown in FIGS. 12A and 12B may include elements similar to the LCPH element fabricated based on the processes shown in FIGS. 11A-11F. Descriptions of the similar steps and similar elements, structures, or functions can refer to the descriptions rendered above in connection with FIGS. 11A-11F. Although the substrate and layers are shown as having flat surfaces, in some embodiments, the substrate and layers formed thereon may have curved surfaces.

Similar to the embodiment shown in FIGS. 11A and 11B, the processes shown in FIGS. 12A and 12B may include dispensing (e.g., coating, depositing, etc.) a recording medium on a surface (e.g., a top surface) of the substrate 1105 to form a recording medium layer 1210. The recording medium may be a polarization sensitive recording medium. The recording medium may include an optically recordable and polarization sensitive material (e.g., a photo-alignment material) configured to have a photo-induced optical anisotropy when exposed to a polarized light irradiation. Molecules (or fragments) and/or photo-products of the optically recordable and polarization sensitive material may generate anisotropic angular distributions in a film plane of a layer of the recording medium under a polarized light irradiation. In some embodiments, the recording medium may include or be mixed with other ingredients, such as a solvent in which the optically recordable and polarization sensitive materials may be dissolved to form a solution, and photo-sensitizers. The solution may be dispensed on the substrate 1105 using a suitable process, e.g., spin coating, slot coating, blade coating, spray coating, or jet (ink-jet) coating or printing. The solvent may be removed from the coated solution using a suitable process, e.g., drying, or heating, leaving the recording medium on the substrate 1105.

After the recording medium layer 1210 is formed on the substrate 1105, as shown in FIG. 12B, the recording medium layer 1210 may be exposed to a polarization interference pattern generated based on four recording beams 1121-1124. In some embodiments, although not shown, three recording beams, or five recording beams, etc., may be used to generate the polarization interference pattern. The recording medium layer 1210 may be optically patterned after being exposed to the polarization interference pattern. An orientation pattern of an optic axis of the recording medium layer 1210 in an exposed region may be defined by the polarization interference pattern.

In the embodiment shown in FIGS. 12A and 12B, the recording medium may include a photo-sensitive polymer. Molecules of the photo-sensitive polymer may include one or more polarization sensitive photo-reactive groups embedded in a main polymer chain or a side polymer chain. During the polarization interference exposure process of the recording medium layer 1210, a photo-alignment of the polarization sensitive photo-reactive groups may occur within (or in, inside) a volume of the recording medium layer 1210. That is, a 3D polarization field or 3D polarization variations generated by the interface of the recording beams 1121-1124 may be directly recorded within (or in, inside) the volume of the recording medium layer 1210. In the embodiment shown in FIGS. 12A and 12B, a 3D orientation pattern of the optic axis may be directly recorded in the recording medium layer 1210 via the bulk-mediated photo-alignment in an exposed region. A step of disposing an additional optically anisotropic layer on the patterned recording medium layer 1210 may be omitted. The patterned recording medium layer 1210 may function as an LCPH element 1200.

The alignment procedure shown in FIG. 12B may be referred to as a bulk-mediated photo-alignment. The recording medium layer 1210 for a bulk-mediated photo-alignment shown in FIG. 12B may be relatively thicker than the recording medium layer 1110 for a surface-mediated photo-alignment shown in FIGS. 11A-11F. The recording medium included in the recording medium layer 1210 for a bulk-mediated photo-alignment shown in FIG. 12B may also be referred to as a volume recording medium or bulk PAM.

In some embodiments, the photo-sensitive polymer included in the recording medium layer 1210 may include an amorphous polymer, an LC polymer, etc. The molecules of the photo-sensitive polymer may include one or more polarization sensitive photo-reactive groups embedded in a main polymer chain or a side polymer chain. In some embodiments, the polarization sensitive photo-reactive group may include an azobenzene group, a cinnamate group, or a coumarin group, etc. In some embodiments, the photo-sensitive polymer may be an amorphous polymer, which may be initially optically isotropic prior to undergoing the polarization interference exposure process, and may exhibit an induced (e.g., photo-induced) optical anisotropy after being subjected to the polarization interference exposure process. In some embodiments, the photo-sensitive polymer may be an LC polymer, in which the birefringence and in-plane orientation pattern may be recorded due to an effect of photo-induced optical anisotropy. In some embodiments, the photo-sensitive polymer may be an LC polymer with a polarization sensitive cinnamate group embedded in a side polymer chain. In some embodiments, when the recording medium layer 1210 includes an LC polymer, the patterned recording medium layer 1210 may be heat treated (e.g., annealed) in a temperature range corresponding to a liquid crystalline state of the LC polymer to enhance the photo-induced optical anisotropy of the LC polymer (not shown in FIG. 12B).

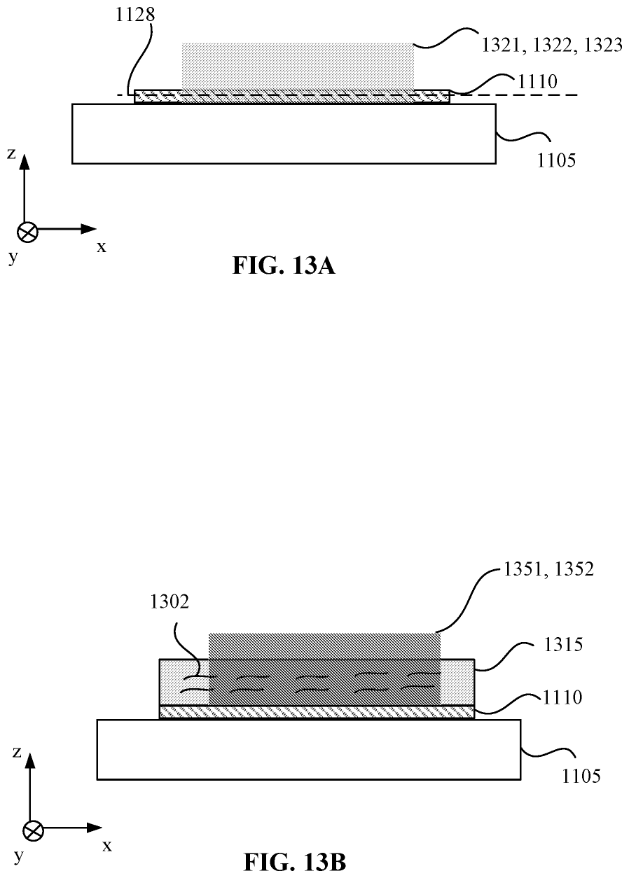

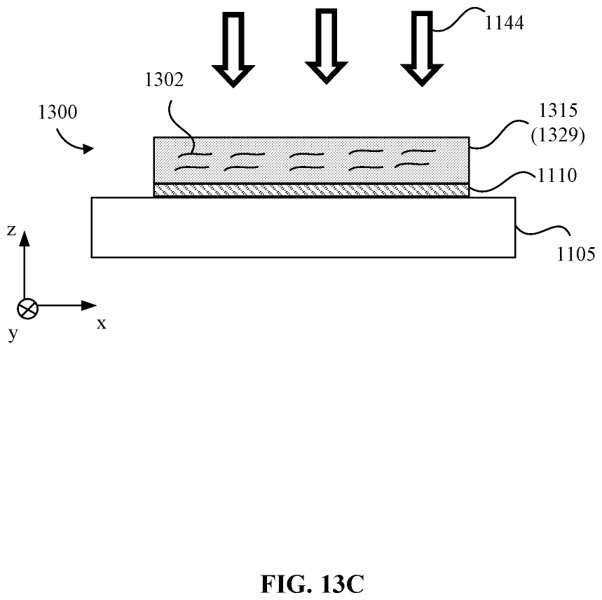

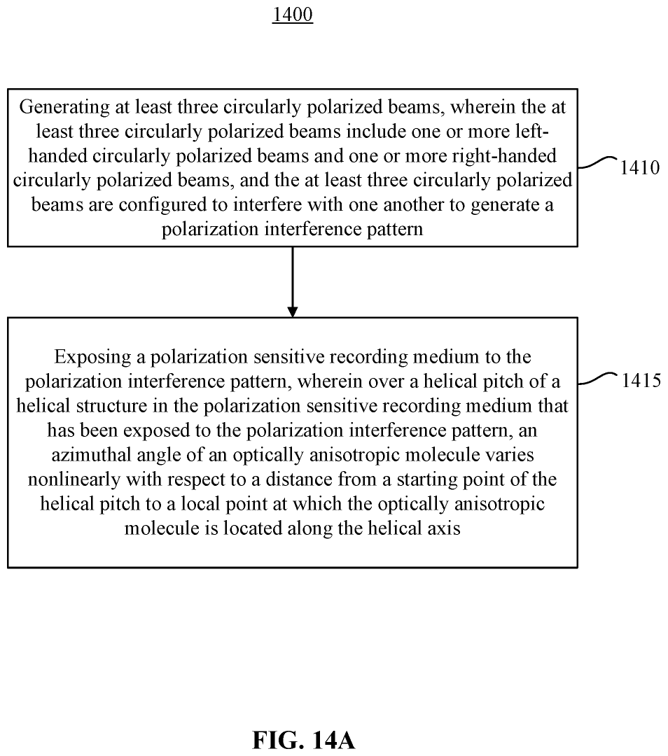

FIGS. 13A-13C schematically illustrate processes for fabricating an LCPH element with a nonlinear azimuthal angle variation, according to an embodiment of the present disclosure. The fabrication processes shown in FIGS. 13A-13C may include holographic recording and surface-mediated photo-alignment. The fabrication processes shown in FIGS. 13A-13C may include steps similar to those shown in FIGS. 11A-11F. The LCPH element fabricated based on the processes shown in FIGS. 13A-13C may include elements similar to the LCPH element fabricated based on the processes shown in FIGS. 11A-11F. Descriptions of the similar steps and similar elements, structures, or functions can refer to the descriptions rendered above in connection with FIGS. 11A-11F. Although the substrate and layers are shown as having flat surfaces, in some embodiments, the substrate and layers formed thereon may have curved surfaces.

Similar to the embodiment shown in FIGS. 11A and 11B, the processes shown in FIG. 13A may include dispensing (e.g., coating, depositing, etc.) a recording medium on a surface (e.g., a top surface) of the substrate 1105 to form the recording medium layer 1110. The recording medium layer 1110 may be exposed to a nonlinear polarization interference pattern generated based on a plurality of recording beams 1321-1323. The recording beams 1321-1323 may be similar to the recording beams 1121-1124 shown in FIG. 11B. For example, the recording beams 1321-1323 may be coherent circularly polarized beams, including at least one left-handed circularly polarized recording beam and at least one right-handed circularly polarized recording beam. For discussion purposes, FIG. 13A shows that three recording beams 1321-1323, e.g., two right-handed circularly polarized beams 1321 and 1322 and a left-handed circularly polarized beam 1323, are used to generate the nonlinear polarization interference pattern. In some embodiments, although not shown, four recording beams, or five recording beams, etc. may be used to generate the nonlinear polarization interference pattern.

In some embodiments, the nonlinear polarization interference pattern generated based on the recording beams 1321-1323 may result from a superposition of a first linear polarization interference pattern generated based on the right-handed circularly polarized recording beam 1321 and the left-handed circularly polarized recording beam 1323, and a second linear polarization interference pattern generated based on the right-handed circularly polarized recording beam 1322 and the left-handed circularly polarized recording beam 1323. For example, referring to FIG. 11B, the right-handed circularly polarized recording beam 1321 and the left-handed circularly polarized recording beam 1323 may interfere with one another to generate the first linear polarization interference pattern with a first pitch P₁ in the in-plane direction 1128. Over a single first pitch P₁ of the first linear polarization interference pattern, an angle of the orientation (or polarization direction) of the linear polarization with respect to the in-plane direction 1128 may be configured to vary along the in-plane direction 1128 in a first predetermined linear manner (or according to a first predetermined linear function). In addition, the right-handed circularly polarized recording beam 1322 and the left-handed circularly polarized recording beam 1323 may interfere with one another to generate the second linear polarization interference pattern with a second pitch P₂ in the in-plane direction 1128. Over a single second pitch P₂ of the second linear polarization interference pattern, an angle of the orientation (or polarization direction) of the linear polarization with respect to the in-plane direction 1128 may be configured to vary along the in-plane direction 1128 in a second predetermined linear manner (or according to a second predetermined linear function).

In some embodiments, a first angle formed between the right-handed circularly polarized recording beam 1321 and the left-handed circularly polarized recording beam 1323 may be configured to be different from a second angle formed between the right-handed circularly polarized recording beam 1322 and the left-handed circularly polarized recording beam 1323. Thus, the first pitch P₁ of the first linear polarization interference pattern may be configured to be different from the second pitch P₂ of the second linear polarization interference pattern, and the first predetermined linear manner may be configured to be different from the first predetermined linear manner. A superposition of the first linear polarization interference pattern and the second linear polarization interference pattern may generate the nonlinear polarization interference pattern.

Similar to the processes shown in FIG. 11D, the processes shown in FIG. 13B may include forming an optically anisotropic layer 1315 on the patterned recording medium layer 1110 by dispensing a birefringent medium onto the patterned recording medium layer 1110. The birefringent medium forming the optically anisotropic layer 1315 may be similar to the birefringent medium forming the optically anisotropic film 1115a shown in FIG. 11D. For example, the birefringent medium may include a host birefringent material having an intrinsic birefringence, such as non-polymerizable LCs or polymerizable LCs (e.g., RMs), and a photo-responsive chiral dopant 1302. The patterned recording medium layer 1110 may be configured to provide a surface alignment to LC molecules in the optically anisotropic layer 1315. Accordingly, the LC molecules located in close proximity to the patterned recording medium layer 1110 may exhibit a nonlinear azimuthal angle variation along the in-plane direction 1128.

The photo-responsive chiral dopant 1302 may twist the LC molecules in the host birefringent material to form helical twist structures. The photo-responsive chiral dopant 1302 may have a photo-responsive HTP, which may vary upon being exposed to a light irradiation of a suitable wavelength range, due to the photo-isomerization of the photo-responsive chiral dopant 1302. The HTP of the photo-responsive chiral dopant 1302 may vary (e.g., increase, decrease, or reverse the handedness) as the degree of the photo-isomerization of the photo-responsive chiral dopant 1302 varies. In some embodiments, the photo-isomerization of the photo-responsive chiral dopant 1302 may be reversible. The light irradiation used for varying the HTP of the photo-responsive chiral dopant 1302 (or to which the photo-responsive chiral dopant 1302 is sensitive) may be referred to as a stimulus irradiation.

The stimulus irradiation may only activate the stimuli-responsive chiral dopant 1302 to change the HTP, and may not activate the photo-initiator (if included in the birefringent medium) to generate the polymerization initiating species. The wavelength (or wavelength range) of the stimulus irradiation may be within (or correspond to) the UV wavelength range, the visible wavelength range, the infrared wavelength range, or a combination thereof, depending on different types of photo-responsive chiral dopants. In some embodiments, the photo-responsive chiral dopant 1302 may undergo different degrees of photo-isomerization in response to stimulus irradiations having different light intensities. In some embodiments, the photo-responsive chiral dopant 1302 may include azobenzene, diarylethene overcrowded alkene, spirooxazine, fulgide, α,β-unsaturated ketone, naphthopyran, or a combination thereof.

As shown in FIG. 13B, the optically anisotropic layer 1315 may be exposed to an intensity interference pattern generated based on two recording beams 1351 and 1352. The recording beams 1351 and 1352 may be coherent polarized beams having the same polarization, e.g., the recording beams 1351 and 1352 may be two linearly polarized beams with the same linear polarization direction, or two circularly polarized beams with the same handedness. The recording beams 1351 and 1352 may have a wavelength range to which the photo-responsive chiral dopant 1302 is sensitive. In some embodiments, the interference of the recording beams 1351 and 1352 may result in an intensity interference pattern that has a spatially constant polarization and a spatially varying intensity, within a spatial region in which the recording beams 1351 and 1352 interfere with one another. That is, the intensity interference pattern may exhibit a 3D intensity variations within the spatial region in which the recording beams 1351 and 1352 interfere with one another. The intensity interference pattern having the 3D intensity variations may function as the stimulus irradiation for the photo-responsive chiral dopant 1302.

During the intensity interference pattern exposure of the optically anisotropic layer 1315, the photo-responsive chiral dopant 1302 distributed within the volume of the optically anisotropic layer 1315 may undergo different degrees of photo-isomerization in response to the intensity interference pattern having the 3D intensity variations, resulting in 3D helical twisting power variations of the photo-responsive chiral dopant 1302 within the volume of the optically anisotropic layer 1315. When the weight concentration of the photo-responsive chiral dopant 1302 is presumed to be constant across the optically anisotropic layer 1315, the 3D helical twisting power variations of the photo-responsive chiral dopant 1302 may result in 3D helical pitch variations of the helical twist structures within the volume of the optically anisotropic layer 1315. In some embodiments, through configuring the two recording beams 1351 and 1352, the 3D helical pitch variations of the helical twist structures within the volume of the optically anisotropic layer 1315 may be configured, which may result in a predetermined nonlinear azimuthal angle variation of the LC molecules along the helical axis of the helical twist structures.

In some embodiments, as shown in FIG. 13C, after the intensity interference pattern exposure, the optically anisotropic layer 1315 may be exposed to the polymerization irradiation 1144 to form a polymerized optically anisotropic layer 1329, thereby stabilizing the nonlinear azimuthal angle variation. Referring to FIGS. 13B and 13C, the polymerization irradiation 1144 may be different from the stimulus irradiation generated by the recording beams 1351 and 1352. The stimulus irradiation may only activate the photo-responsive chiral dopant 1302 to change the HTP thereof, and may not activate the photo-initiator to generate the polymerization initiating species. That is, the photo-initiator may not respond to the stimulus irradiation, and the stimulus irradiation may not cause the polymerization of the RM material in the optically anisotropic layer 1315. The polymerization irradiation 1144 may only activate the photo-initiator to generate the polymerization initiating species, and may not activate the photo-responsive chiral dopant 1302 to vary the HTP. That is, the photo-responsive chiral dopant 1302 may not respond to the polymerization irradiation, and the polymerization irradiation may not change the HTP of the photo-responsive chiral dopant 1302.

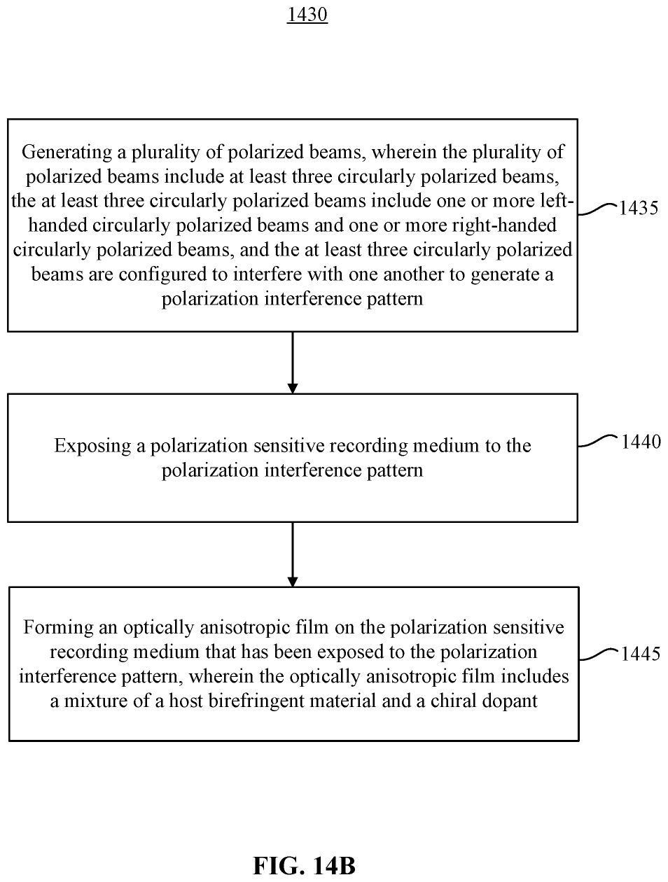

FIGS. 14A and 14B are flowcharts illustrating various methods for fabricating an LCPH element with a nonlinear azimuthal angle variation, according to various embodiments of the present disclosure. FIG. 14A is a flowchart illustrating a method 1400 for fabricating an LCPH element with a nonlinear azimuthal angle variation, according to an embodiment of the present disclosure. As shown in FIG. 14A, the method 1400 may include generating at least three circularly polarized beams, wherein the at least three circularly polarized beams include one or more left-handed circularly polarized beams and one or more right-handed circularly polarized beams, and the at least three circularly polarized beams are configured to interfere with one another to generate a polarization interference pattern (step 1410). The method 1400 may also include exposing a polarization sensitive recording medium to the polarization interference pattern, wherein over a helical pitch of a helical structure in the polarization sensitive recording medium that has been exposed to the polarization interference pattern, an azimuthal angle of an optically anisotropic molecule varies nonlinearly with respect to a distance from a starting point of the helical pitch to a local point at which the optically anisotropic molecule is located along the helical axis (step 1415).

In some embodiments, the at least three circularly polarized beams may include a first beam, a second beam, and a third beam, and a first angle formed between the first beam and the second beam is different from a second angle formed between the second beam and the third beam. In some embodiments, the polarization sensitive recording medium may include a bulk photo-alignment material, and exposing the polarization sensitive recording medium to the polarization interference pattern may result in the polarization interference pattern being recorded in the bulk photo-alignment material.

FIG. 14B is a flowchart illustrating a method 1430 for fabricating an LCPH element with a nonlinear azimuthal angle variation, according to an embodiment of the present disclosure. The method 1430 may include generating a plurality of polarized beams, wherein the plurality of polarized beams include at least three circularly polarized beams, the at least three circularly polarized beams include one or more left-handed circularly polarized beams and one or more right-handed circularly polarized beams, and the at least three circularly polarized beams are configured to interfere with one another to generate a polarization interference pattern (step 1435). The method 1430 may also include exposing a polarization sensitive recording medium to the polarization interference pattern (step 1440). The method 1430 may also include forming an optically anisotropic film on the polarization sensitive recording medium that has been exposed to the polarization interference pattern, wherein the optically anisotropic film includes a mixture of a host birefringent material and a chiral dopant (step 1445).

In some embodiments, the polarization sensitive recording medium may include a surface photo-alignment material. In some embodiments, the optically anisotropic film may be a first optically anisotropic film, the mixture may be a first mixture of the host birefringent material and a first chiral dopant, and the first chiral dopant may have a first helical twisting power and a first weight concentration in the first mixture. The method 1430 may further include forming a second optically anisotropic film on the first optically anisotropic film. The second optically anisotropic film may include a second mixture of the host birefringent material and a second chiral dopant, and the second chiral dopant may have a second helical twisting power and a second weight concentration in the second mixture. The first chiral dopant and the second chiral dopant may be configured to have at least one difference in the first helical twisting power and the second helical twisting power or in the first weight concentration and the second weight concentration. In some embodiments, the method 1430 may further include exposing the first optically anisotropic film and the second optically anisotropic film to a polymerization irradiation.

In some embodiments, the chiral dopant may include a photo-responsive chiral dopant, and the plurality of polarized beams are a first plurality of polarized beams, the method 1430 may also include: generating a second plurality of polarized beams, wherein the second plurality of polarized beams include two polarized beams configured to interfere with one another to generate an intensity interference pattern within a spatial region in which the optically anisotropic film is disposed. The method 1430 may also include exposing the optically anisotropic film to the intensity interference pattern. In some embodiments, the method may further include exposing the optically anisotropic film to a polymerization irradiation.

In some embodiments, the present disclosure provides a method. The method includes directing a plurality of polarized beams toward a polarization sensitive recording medium. The plurality of polarized beams include at least three circularly polarized beams, the at least three circularly polarized beams include one or more left-handed circularly polarized beams and one or more right-handed circularly polarized beams, and the at least three circularly polarized beams are configured to interfere with one another to generate a polarization interference pattern. The method also includes exposing the polarization sensitive recording medium to the polarization interference pattern. In some embodiments, the at least three circularly polarized coherent beams include a first beam, a second beam, and a third beam, and a first angle formed between the first beam and the second beam is different from a second angle formed between the second beam and the third beam. In some embodiments, the polarization sensitive recording medium includes a bulk photo-alignment material, and exposing the polarization sensitive recording medium to the polarization interference pattern results in the polarization interference pattern being recorded in the bulk photo-alignment material.

In some embodiments, the polarization sensitive recording medium includes a surface photo-alignment material, and after exposing the polarization sensitive recording medium to the polarization interference pattern, the method further includes forming an optically anisotropic film based on a mixture of a host birefringent material and a chiral dopant on the polarization sensitive recording medium. In some embodiments, the optically anisotropic film based on the mixture of the host birefringent material and the chiral dopant is a first optically anisotropic film based on a first mixture of the host birefringent material and a first chiral dopant, the first chiral dopant having a first helical twisting power and a first weight concentration in the first mixture. The method further includes: forming a second optically anisotropic film based on a second mixture of the host birefringent material and a second chiral dopant on the first optically anisotropic film, the second chiral dopant having a second helical twisting power and a second weight concentration in the second mixture. The first chiral dopant and the second chiral dopant are configured to have at least one difference in the first helical twisting power and the second helical twisting power or in the first weight concentration and the second weight concentration. In some embodiments, the method further includes exposing the first optically anisotropic film and the second optically anisotropic film to a polymerization irradiation.

In some embodiments, the chiral dopant includes a photo-responsive chiral dopant, and the plurality of polarized beams are a first plurality of polarized beams, the method further includes: directing a second plurality of polarized beams toward the optically anisotropic film, the second plurality of polarized beams include two polarized beams configured to interfere with one another to generate an intensity interference pattern within a spatial region in which the optically anisotropic film is disposed; and exposing the optically anisotropic film to the intensity interference pattern. In some embodiments, the method further includes exposing the optically anisotropic film to a polymerization irradiation.

In some embodiments, the present disclosure provides a device including an optical film including optically anisotropic molecules configured to form a plurality of helical structures with a plurality of helical axes and a helical pitch. The helical pitch is a distance along a helical axis over which an azimuthal angle of an optically anisotropic molecule vary by a predetermined value. Over the helical pitch of a helical structure, the azimuthal angle of the optically anisotropic molecule is configured to vary nonlinearly with respect to a distance from a starting point of the helical pitch to a local point at which the optically anisotropic molecule is located along the helical axis.

In some embodiments, over the helical pitch of the helical structure, the azimuthal angle of the optically anisotropic molecule located at the starting point of the helical pitch is zero degree, and the predetermined value associated with the helical pitch is 180 degrees. In some embodiments, the optical film is configured to provide a primary reflection band and at least one secondary reflection band that is spaced apart from the primary reflection band. In some embodiments, the primary reflection band and the at least one secondary reflection band include a red wavelength range and a blue wavelength range. In some embodiments, the optical film is a first optical film, and the device further includes a second optical film configured to provide a reflection band that includes a green wavelength range. In some embodiments, the at least one secondary reflection band includes two secondary reflection bands located at different sides of the primary reflection band. In some embodiments, the primary reflection band includes a green wavelength range, and the two secondary reflection bands include a red wavelength range and a blue wavelength range. In some embodiments, for a polarized light having a wavelength range within the primary reflection band or the at least one secondary reflection band, the optical film is configured to reflect the polarized light when the polarized light has a first handedness, and transmit the polarized light when the polarized light has a second handedness that is opposite to the first handedness.

In some embodiments, the optical film is configured to: reflect a first polarized light in a first reflection angle, the first polarized light having a first wavelength range within the primary reflection band and a predetermined handedness, and reflect a second polarized light in a second reflection angle that is different from the first reflection angle, the second polarized light having a second wavelength range within the at least one secondary reflection band and the predetermined handedness.

In some embodiments, the optical film is configured to: reflect a first polarized light in a first reflection angle, the first polarized light having a first wavelength range within the primary reflection band and a predetermined handedness, and reflect a second polarized light in a second reflection angle that is the same as the first reflection angle, the second polarized light having a second wavelength range within the at least one secondary reflection band and the predetermined handedness.

In some embodiments, over the helical pitch of the helical structure, the azimuthal angle of the optically anisotropic molecule varies according to a function

$$φ ( z ) = 180 ° * \frac{z}{{P}_{B}} + f ( A , n , \frac{z}{{P}_{B}} ) .$$

The φ is the azimuthal angle of the optically anisotropic molecule, z is the distance from the starting point of the helical pitch to the local point at which the optically anisotropic molecule is located along the helical axis, and P_{B} is a Bragg period,

$$180 ° * \frac{z}{{P}_{B}}$$

is a linear function of z,

$$f ( A , n , \frac{z}{{P}_{B}} )$$

is a nonlinear function of z, A is an amplitude parameter of the nonlinear function and is a positive value smaller than or equal to 360°, n is a frequency parameter of the nonlinear function and is a positive value smaller than or equal to 1.

In some embodiments, the nonlinear function

$$f ( A , n , \frac{z}{{P}_{B}} ) is f ( A , n , \frac{z}{{P}_{B}} ) = A * Sin ( n * 360 ° * \frac{z}{{P}_{B}} ) ,$$

and the function

$$φ ( z ) is φ ( z ) = 180 ° * \frac{z}{{P}_{B}} + A * Sin ( n * 360 ° * \frac{z}{{P}_{B}} ) .$$

In some embodiments, the optical film includes a cholesteric liquid crystal (“CLC”) layer, and the optically anisotropic molecules located in close proximity to a surface of the optical film are configured in a uniform in-plane orientation pattern.

In some embodiments, the optical film includes a reflective polarization volume hologram (“PVH”) layer, and the optically anisotropic molecules located in close proximity to a surface of the optical film are configured in a non-uniform in-plane orientation pattern with an in-plane pitch along a predetermined in-plane direction, the in-plane pitch being defined as a distance along the predetermined in-plane direction over which the azimuthal angles of the optically anisotropic molecules located in close proximity to the surface of the optical film vary by 180°.

In some embodiments, over the in-plane pitch of the non-uniform in-plane orientation pattern, the azimuthal angle of the optically anisotropic molecule located in close proximity to the surface of the optical film is configured to vary nonlinearly with respect to a distance from a starting point of the in-plane pitch to a local point at which the optically anisotropic molecule is located along the predetermined in-plane direction, and over the in-plane pitch of the non-uniform in-plane orientation pattern, the azimuthal angle of the optically anisotropic molecule located at the starting point of the in-plane pitch is zero degree.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
an optical film including optically anisotropic molecules configured to form a plurality of helical structures with a plurality of helical axes and a helical pitch,
wherein the helical pitch is a distance along a helical axis over which an azimuthal angle of an optically anisotropic molecule vary by a predetermined value, and
wherein over the helical pitch of a helical structure, the azimuthal angle of the optically anisotropic molecule is configured to vary nonlinearly with respect to a distance from a starting point of the helical pitch to a local point at which the optically anisotropic molecule is located along the helical axis.

2. The device of claim 1, wherein over the helical pitch of the helical structure, the azimuthal angle of the optically anisotropic molecule located at the starting point of the helical pitch is zero degree, and the predetermined value associated with the helical pitch is 180 degrees.

3. The device of claim 1, wherein the optical film is configured to provide a primary reflection band and at least one secondary reflection band that is spaced apart from the primary reflection band.

4. The device of claim 3, wherein the primary reflection band and the at least one secondary reflection band include a red wavelength range and a blue wavelength range.

5. The device of claim 4, wherein the optical film is a first optical film, and the device further includes a second optical film configured to provide a reflection band that includes a green wavelength range.

6. The device of claim 3, wherein the at least one secondary reflection band includes two secondary reflection bands located at different sides of the primary reflection band.

7. The device of claim 6, wherein the primary reflection band includes a green wavelength range, and the two secondary reflection bands include a red wavelength range and a blue wavelength range.

8. The device of claim 3, wherein for a polarized light having a wavelength range within the primary reflection band or the at least one secondary reflection band, the optical film is configured to reflect the polarized light when the polarized light has a first handedness, and transmit the polarized light when the polarized light has a second handedness that is opposite to the first handedness.

9. The device of claim 3, wherein the optical film is configured to:
reflect a first polarized light in a first reflection angle, the first polarized light having a first wavelength range within the primary reflection band and a predetermined handedness, and
reflect a second polarized light in a second reflection angle that is different from the first reflection angle, the second polarized light having a second wavelength range within the at least one secondary reflection band and the predetermined handedness.

10. The device of claim 3, wherein the optical film is configured to:
reflect a first polarized light in a first reflection angle, the first polarized light having a first wavelength range within the primary reflection band and a predetermined handedness, and
reflect a second polarized light in a second reflection angle that is the same as the first reflection angle, the second polarized light having a second wavelength range within the at least one secondary reflection band and the predetermined handedness.

11. The device of claim 1,
wherein over the helical pitch of the helical structure, the azimuthal angle of the optically anisotropic molecule varies according to a function
$$φ ( z ) = 180 ° * \frac{z}{{P}_{B}} + f ( A , n , \frac{z}{{P}_{B}} ) ,$$
wherein φ is the azimuthal angle of the optically anisotropic molecule, z is the distance from the starting point of the helical pitch to the local point at which the optically anisotropic molecule is located along the helical axis, and P_{B} is a Bragg period,
$$180 ° * \frac{z}{{P}_{B}}$$
is a linear function of z,
$$f ( A , n , \frac{z}{{P}_{B}} )$$
is a nonlinear function of z, A is an amplitude parameter of the nonlinear function and is a positive value smaller than or equal to 360°, n is a frequency parameter of the nonlinear function and is a positive value smaller than or equal to 1.

12. The device of claim 11, wherein the nonlinear function
$$f ( A , n , \frac{z}{{P}_{B}} ) is f ( A , n , \frac{z}{{P}_{B}} ) = A * Sin ( n * 360 ° * \frac{z}{{P}_{B}} ) ,$$
and the function
$$φ ( z ) is φ ( z ) = 180 ° * \frac{z}{{P}_{B}} + A * Sin ( n * 360 ° * \frac{z}{{P}_{B}} ) .$$

13. The device of claim 1, wherein
the optical film includes a cholesteric liquid crystal (“CLC”) layer, and
the optically anisotropic molecules located in close proximity to a surface of the optical film are configured in a uniform in-plane orientation pattern.

14. The device of claim 1, wherein
the optical film includes a reflective polarization volume hologram (“PVH”) layer, and
the optically anisotropic molecules located in close proximity to a surface of the optical film are configured in a non-uniform in-plane orientation pattern with an in-plane pitch along a predetermined in-plane direction, the in-plane pitch being defined as a distance along the predetermined in-plane direction over which the azimuthal angles of the optically anisotropic molecules located in close proximity to the surface of the optical film vary by 180°.

15. The device of claim 14, wherein
over the in-plane pitch of the non-uniform in-plane orientation pattern, the azimuthal angle of the optically anisotropic molecule located in close proximity to the surface of the optical film is configured to vary nonlinearly with respect to a distance from a starting point of the in-plane pitch to a local point at which the optically anisotropic molecule is located along the predetermined in-plane direction, and
over the in-plane pitch of the non-uniform in-plane orientation pattern, the azimuthal angle of the optically anisotropic molecule located at the starting point of the in-plane pitch is zero degree.

16. A method, including:
generating a plurality of polarized beams, wherein the plurality of polarized beams include at least three circularly polarized beams, the at least three circularly polarized beams include one or more left-handed circularly polarized beams and one or more right-handed circularly polarized beams, and the at least three circularly polarized beams are configured to interfere with one another to generate a polarization interference pattern;
exposing a polarization sensitive recording medium to the polarization interference pattern; and
forming an optically anisotropic film on the polarization sensitive recording medium that has been exposed to the polarization interference pattern, wherein the optically anisotropic film includes a mixture of a host birefringent material and a chiral dopant.

17. The method of claim 16, wherein the optically anisotropic film is a first optically anisotropic film, the mixture is a first mixture of the host birefringent material and a first chiral dopant, the first chiral dopant has a first helical twisting power and a first weight concentration in the first mixture, and the method further comprises:
forming a second optically anisotropic film on the first optically anisotropic film, wherein the second optically anisotropic film includes a second mixture of the host birefringent material and a second chiral dopant, the second chiral dopant has a second helical twisting power and a second weight concentration in the second mixture,
wherein the first chiral dopant and the second chiral dopant are configured to have at least one difference in the first helical twisting power and the second helical twisting power or in the first weight concentration and the second weight concentration.

18. The method of claim 17, further comprising exposing the first optically anisotropic film and the second optically anisotropic film to a polymerization irradiation.

19. The method of claim 16, wherein the chiral dopant includes a photo-responsive chiral dopant, and the plurality of polarized beams are a first plurality of polarized beams, the method further comprises:
generating a second plurality of polarized beams, the second plurality of polarized beams include two polarized beams configured to interfere with one another to generate an intensity interference pattern within a spatial region in which the optically anisotropic film is disposed; and
exposing the optically anisotropic film to the intensity interference pattern.

20. The method of claim 19, further comprising exposing the optically anisotropic film to a polymerization irradiation.
